(19) United States
(12) Patent Application Publication
(10) Pub. No.: US 2011/0047628 A1
(43) Pub. Date: Feb. 24, 2011

(54) IDENTITY VERIFICATION AND INFORMATION MANAGEMENT

(75) Inventor: Alan Viars, Morgantown, WV (US)

Correspondence Address: WILSON, SONSINI, GOODRICH & ROSATI, 650 PAGE MILL ROAD, PALO ALTO, CA, 94304-1050, US

(73) Assignee: VIDENTITY SYSTEMS, INC., MORGANTOWN, WV (US)

(21) Appl. No.: 12/664,351

(22) PCT Filed: Jun. 13, 2008
(86) PCT No.: PCT/US08/66900

§ 371 Date: Jun. 1, 2010

Related U.S. Application Data
(60) Provisional application No. 60/943,764, filed on Jun. 13, 2007.

(51) Int. Cl. G06F 21/00

(52) U.S. Cl. 726/28

(57) ABSTRACT

The present invention provides an efficient, secure and verified information exchange using an identity verification platform and common interface data formats, whereby an individual can set different levels of access for different clients and further set different levels of access for different files. Therefore, the present invention provides a multi-layer access to records particular to an individual.

### BACKGROUND OF THE INVENTION

In general it is known how to access certain records maintained electronically. Additionally, it is generally known that such records can be maintained on a computer, land area network or computer server system. Currently, regarding medical records, patient records are compiled numerous times, often by multiple health providers. In addition, regarding clinical trial data, results, communications a centralized system and/or software to add, modify or access such information while safeguarding identity management is needed. For example, a system where an individual can determine who is authorized to access, modify or review information particular to that individual can benefit many individuals. Furthermore, there is a need for such a system which can optimize payment exchange amongst the individual, the individual's medical/health care provider and/or other third parties (e.g., health insurance underwriter). For example, personal health record management and access is costly, frustrating for patients and medical professionals, who often compile and transport medical records multiple times, to and from multiple health providers, increasing the likelihood of lost/misplaced files, medical mistakes, administrative costs and even malpractice suits.

An effective service-oriented architecture system is needed which allows multi-level access and co-ordination of information, communication amongst different users.

### SUMMARY OF THE INVENTION

In general, the present invention provides an efficient, secure and verified information exchange using an identity verification platform and common interface data formats, whereby an individual can set different levels of access for different clients and further set different levels of access for different files. Therefore, the present invention provides a multi-layer access to records particular to an individual.

In one aspect of the invention, an identity management comprising providing one or more identity verification inputs by a primary client user and/or one or more secondary client users, comparing said identity verification inputs to data stored on an identity verification subsystem linked to a server, whereby the one or more secondary users can access, view, post, download, modify/edit one or more files stored on the server that are associated with a primary client user. The server comprises computer executable logic which functions to synchronize files into a single, common language. Furthermore, the server allows multiple primary client users, for each of whom multiple data files/content are comprised on the server, and for each of whom multiple secondary client users may access such files/content on a one-time or continuous basis. The server allows linking via any electronic means known in the art (e.g., internet, satellite, digital/analog communication and hybrid land/satellite communications) to one or more financial/banking account(s) belonging to either a primary client user or a secondary client user.

Therefore, in some embodiments, the server allows users to submit a request for funds to be transferred from a payer to a payee. Payers can be a primary client user and/or a secondary client user. Furthermore, a payee can also be a primary client user and/or a secondary client user. For example, in one embodiment, a primary client user can request that funds be transferred from a financial/bank account to a service provider (e.g., a primary client user can request funds to be transferred from a bank account to a State agency account, such as to effect payment transfer for payment of taxes due, payment of fees for automobile registration, payment for fees due a care giver, payment due to a physician). In another example, a secondary user (payer) can request transfer of funds to a primary client user (payee) to pay for services due to third parties who may/may not be secondary client users as well.

In any of the embodiments disclosed herein, the server comprises an identity verification subsystem responds to a request for an identity verification input which is compared to information/files stored on the server to determine if the requestor (e.g., any user) is authorized for a particular transaction.

Another feature of the server of the invention is that a messaging subsystem is also comprised on the server which comprises executable logic that functions to send notices/messages to a primary client user or secondary client user to notify a user of a request and/or transaction.

Furthermore, in various embodiments of the invention, a primary client user can preset what files/content is accessible by which secondary client user. Therefore, the server/software functions to allow a primary client user to pre-set multiple layers of security/access. For example, in various embodiments a primary client user determines that one primary client user can access one type/group of files particular to the primary client user, while another secondary user has access to the same or different type/group of files. Thus in some examples, a layer of security/access is defined by the type of files accessed (“F” for files) and another layer of security/access is defined by who can access particular type of file (“U” for user). A further layer of security/access comprises what action (“A” for action) can be done with a particular file (e.g., view, edit, post, etc). Thus for example, the different layers of security/access is F x U x A; another is F x U; another is F x A; another is A x U.

In another aspect of the invention, a claims adjudication subserver is comprised on the server which stores an index of different items which correspond to a corresponding fee (e.g., National Electronic Health Information Transmission Specification (NEHITS) described infra which comprises an index of medical/pharmaceutical items/procedures/services which correspond to a set fee). Thus, the claims adjudication subserver allows rapid processing of a request for payment (e.g., electronic funds transfer between/amongst two or more financial/bank accounts) from a payer account to a payee account. For example, in one embodiment, the request for payment is for renewal of a driver license which corresponds to a numeric, alphanumeric, or alphabetic code that corresponds to a preset sum of money.

In various embodiments, a primary or secondary user can also preset access by one or more associate account users who can access an account associated with the primary/secondary user. For example, an individual can preset a spouse, family member, relative, sibling, parent or child to access based on preset different layer of security access (e.g., F x U x A). Furthermore, as for any user the server software functions to allow a identify verification input by various means further described herein (e.g., voice, biometrics, numerical code, alphanumeric, etc.).

Therefore, the invention relates to computer readable medium comprising executable logic/software (‘software’) programs that function to normalize various postings, uploaded files/contents, viewing, downloaded, editable files which can be stored on a central database, which are accessible once identity verification is used to authorize access by comparing one or more inputs to identity verification information stored on the system. As described above, the software functions to allow a user to designate different layers of access (which access means accessing a particular file/content and being able to conduct a particular transaction associated with such file/content).

Furthermore, other aspects of the invention are directed to business methods wherein one or more secondary client users pay a fee to register an account on the server to access files/records associated with a primary client user. Of course, the primary client user can respond to any request to access a file/record associated with him/her as described herein. Furthermore, in business methods or systems/methods described herein, multiple secondary client users can post various identifier information associated to a primary client user. In other words, different identifiers associated with a single primary client user can be indexed on the server (or ‘federated’) into a single identifier for the primary user. For example, in one embodiment, various secondary users may have different identifiers for a patient, but the system/server of the invention functions to assign a single identifier for the primary user (e.g., Master Number corresponding to a primary user). Therefore, in one embodiment, a server of the invention comprises a Master Primary User Index (e.g., identifiers corresponding to multiple primary users).

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates one embodiment for the server architecture.

FIG. 2 provides a data flow diagram for a primary client user.

FIG. 3 provides a data flow diagram for a secondary client user.

FIG. 4 provides a data flow diagram for a payer.

FIG. 5 provides a data flow diagram for an employer.

FIG. 6 provides a data flow diagram for a researcher/research institution.

FIG. 7 provides a data flow diagram for a clinical trial.

FIG. 8 provides a diagram of a process request loop (data or funds).

FIG. 9 illustrates some transactions that can be posted.

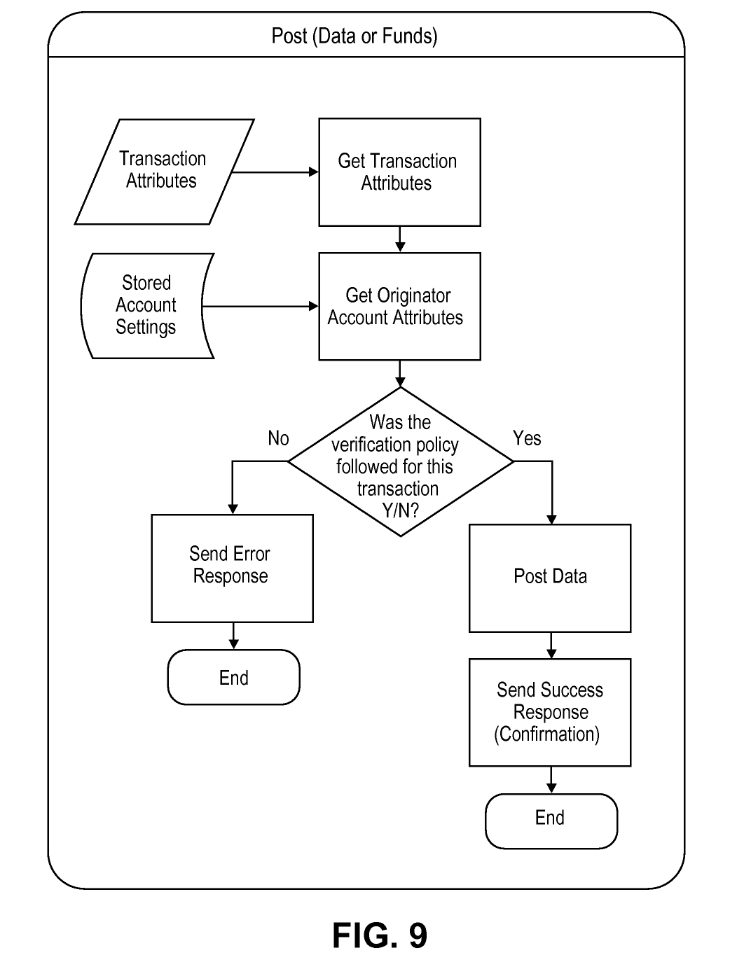

FIG. 10 illustrates some responses for a query.

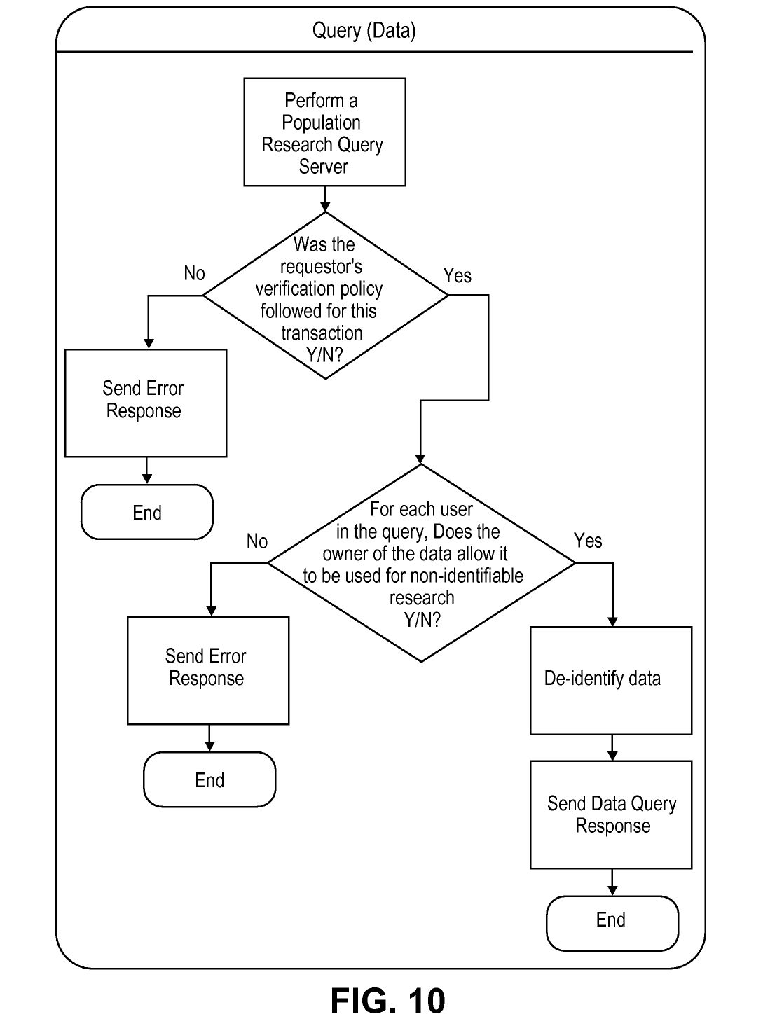

FIG. 11 provides a screen shot for a health spending account.

FIG. 12 provides a screen shot for account/personal information.

FIG. 13 provides a screen shot for setting different levels of secured access for different content.

FIG. 14 provides a screen shot for an associate account.

FIG. 15 provides a screen shot for a confirmation screen.

FIG. 16 provides a screen shot for formularies.

FIG. 17 provides a screen shot of an introduction screen.

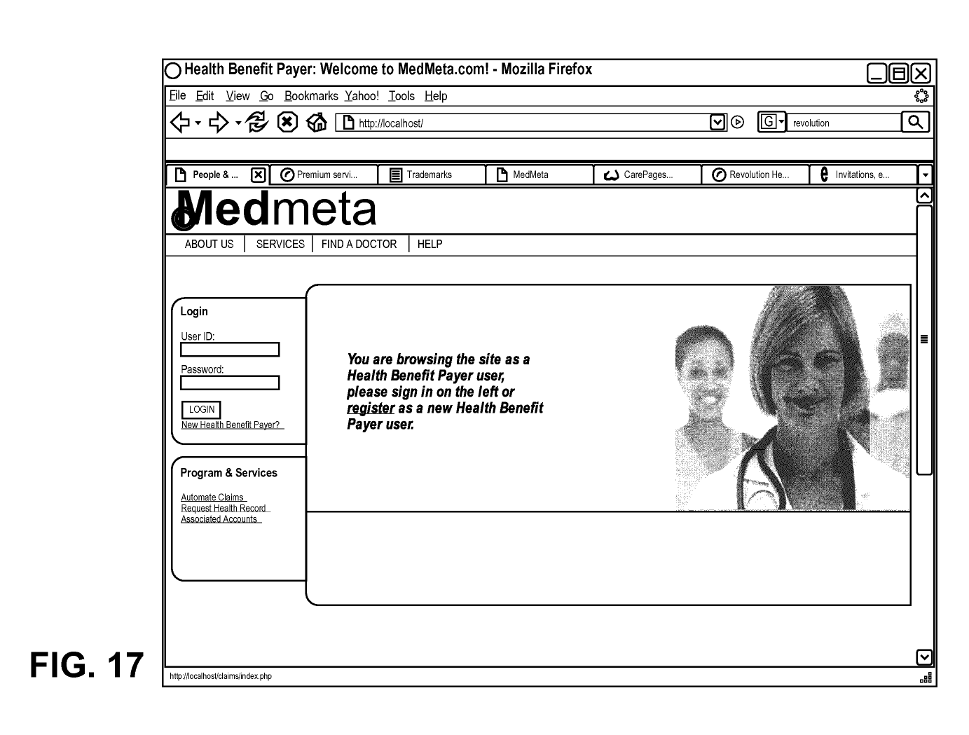

FIG. 18 provides a screen shot of an introduction screen.

FIG. 19 provides a screen shot for a search screen.

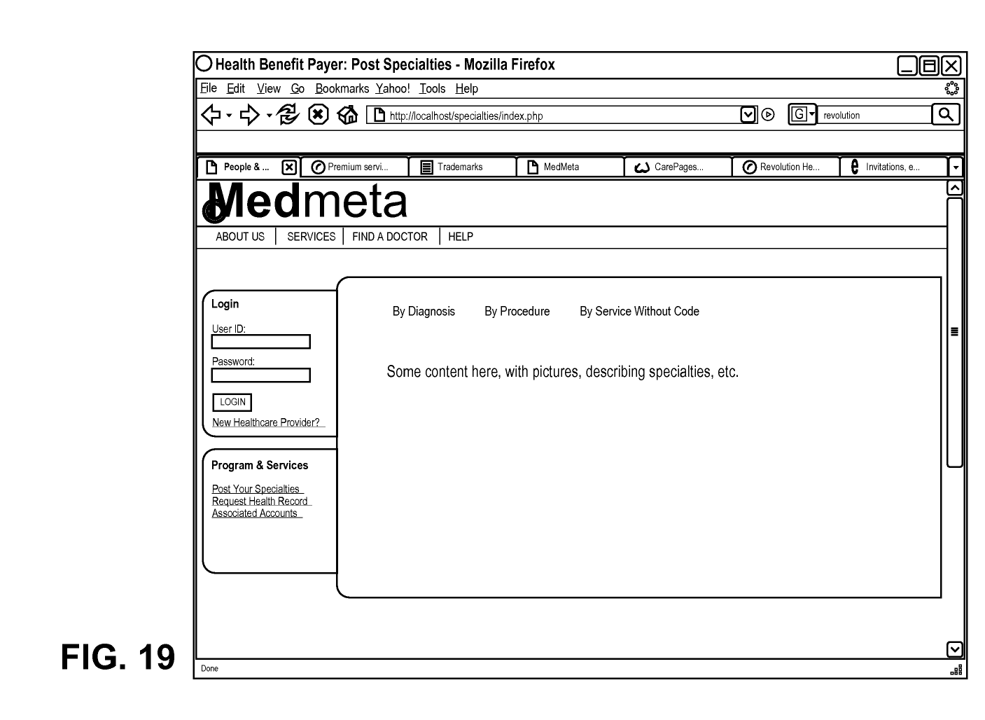

FIG. 20 provides a screen shot for a search screen.

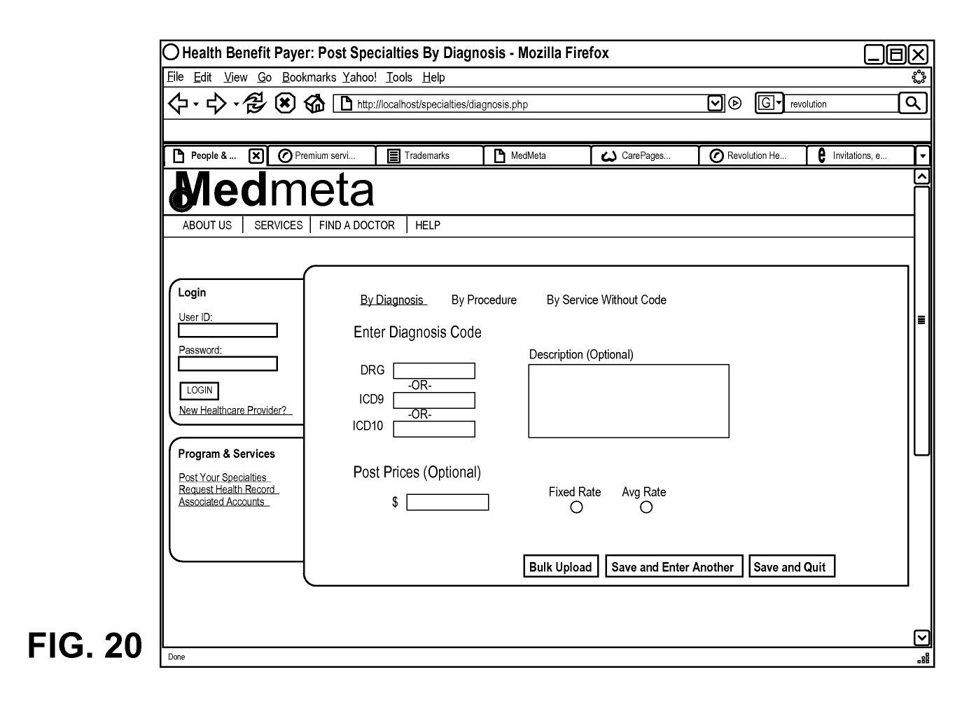

FIG. 21 provides a screen shot for a non-English page.

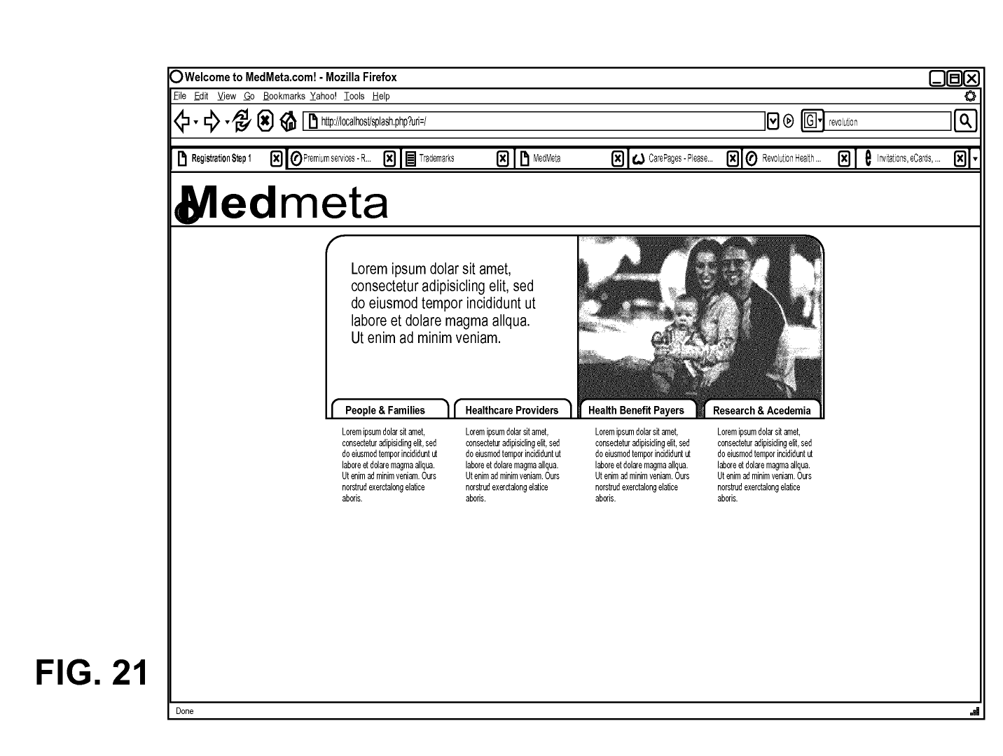

FIG. 22 provides a screen shot for a claim adjudication page.

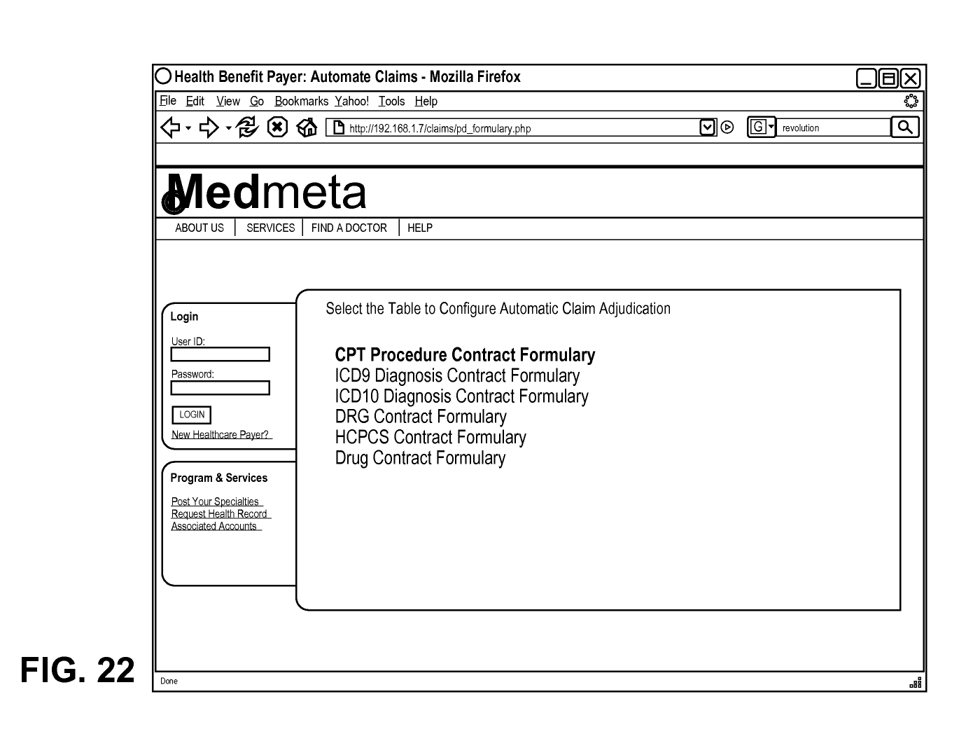

FIG. 23 provides a screen shot for a contract formulary.

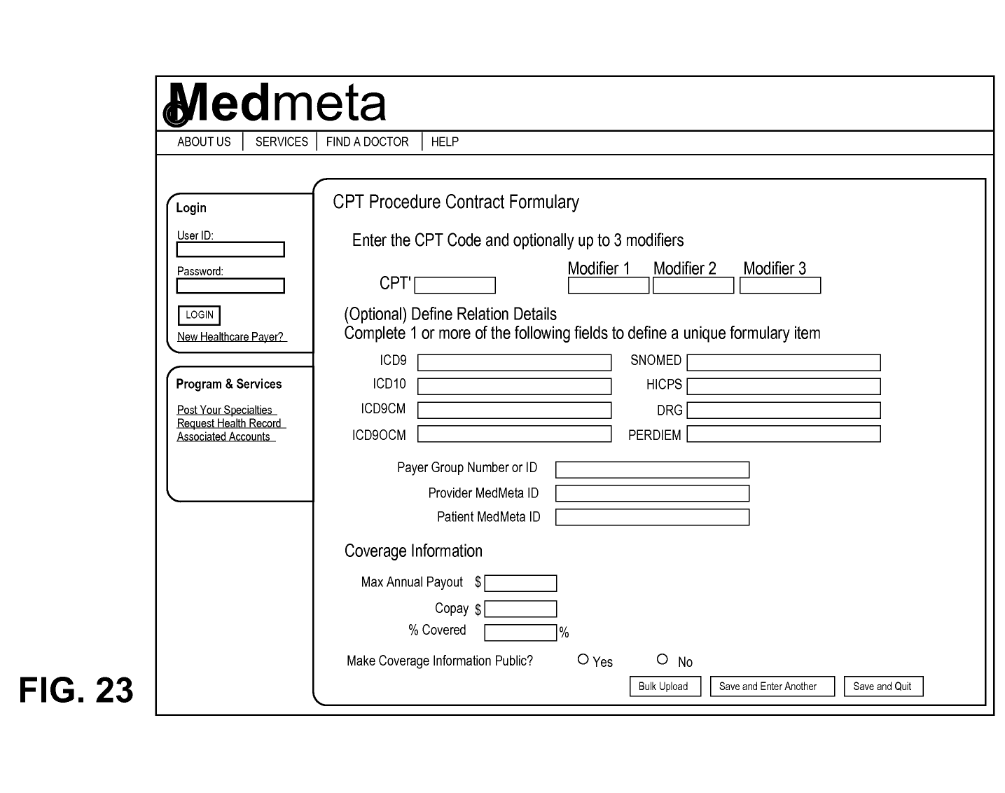

FIG. 24 provides a screen shot for a contract formulary.

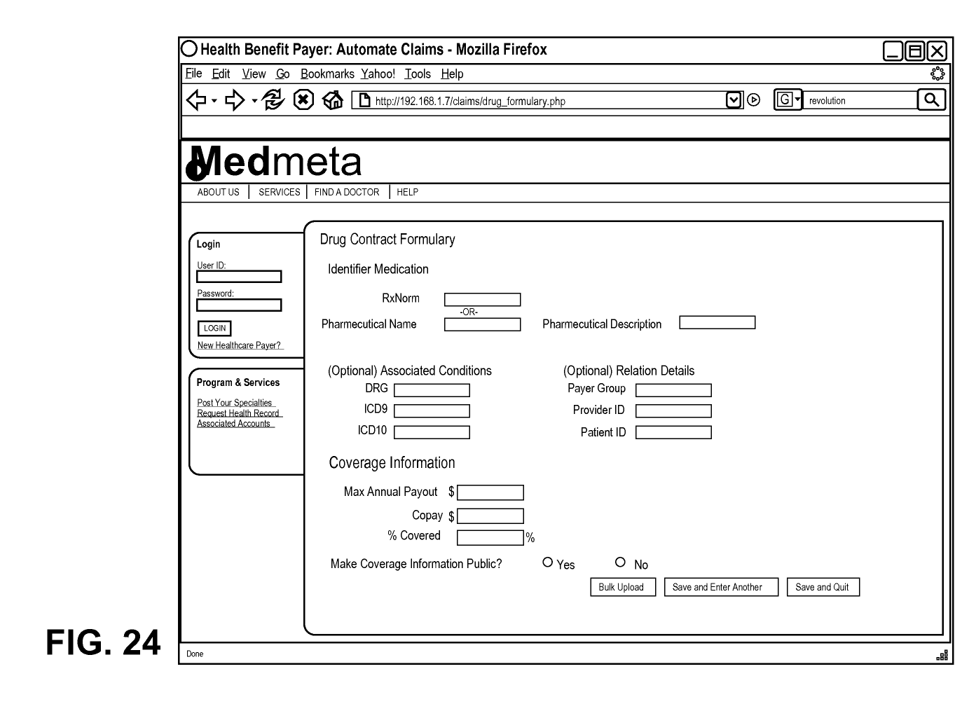

### DETAILED DESCRIPTION OF THE INVENTION

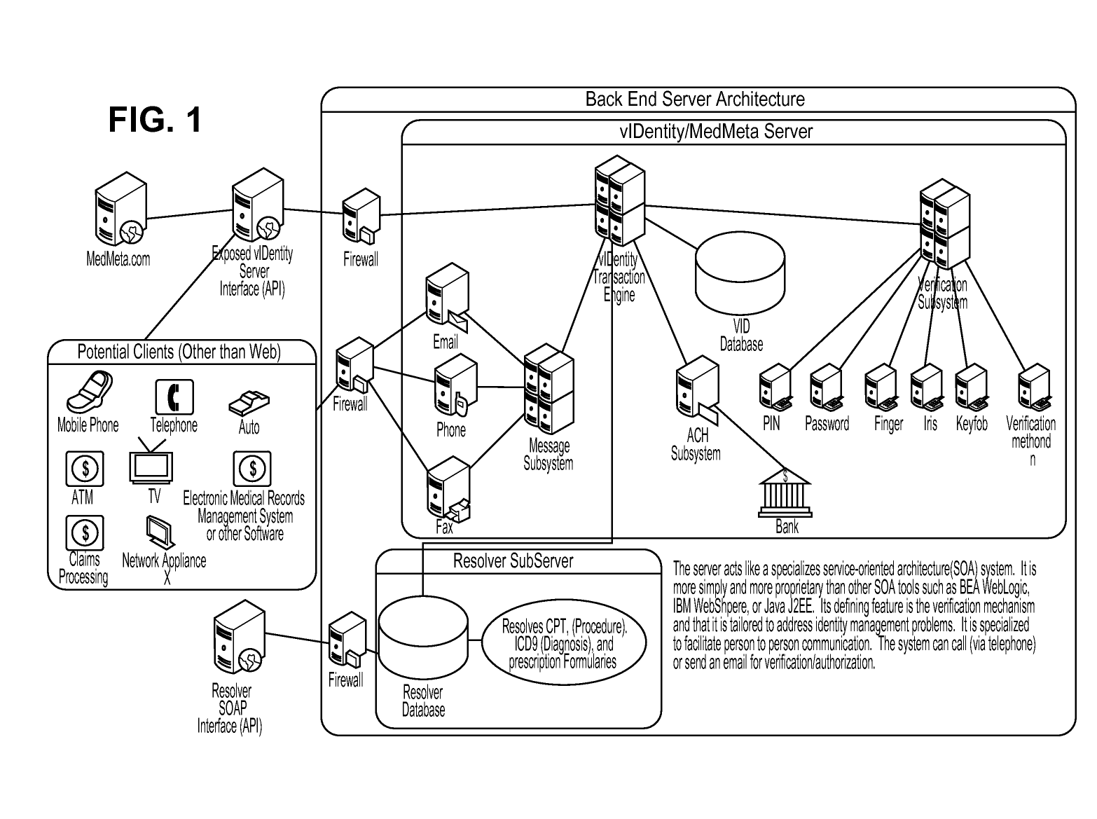

In one aspect of the invention, a server architecture is provided FIG. 1 for access through various interfaces, whereby a plurality of subsystems are operably linked to the server, where such subsystems comprise computer executable logic that conducts various functions such as messaging, electronic funds transfer, identity verification and resolving electronic health information transmission specification codes, including clinical, medical, pharmaceutical or a combination thereof.

As FIG. 1 depicts the invention provides a specialized service-oriented system designed to allow information exchange/management, person to person communication, system to person communication, and predicated on a secured/identity management platform. In various embodiments, the subsystems include a resolver subsystem, a message subsystem, an ACH subsystem and/or a verification subsystem.

One aspect of the invention is directed to an identity management method comprising: providing one or more identity verification inputs by said primary client user and/or one or more secondary client users; comparing said identity verification inputs to identity verification data stored on an identity verification subsystem linked to a server, wherein the server includes a messaging subsystem, wherein if said inputs match said data said user(s) is authorized for access to information on said server, wherein said access comprises different levels of access to different content groupings of said information, wherein said information is particular to said primary client user, wherein said access comprises viewing or modifying said information; accessing of information by a primary client user and one or more secondary client users wherein said information is present on an identify verification subsystem linked to said server, wherein said information is categorized into a plurality of content groups corresponding to a plurality of different access levels, communicating to said primary client user by said messaging subserver notifying said primary client user or preset primary client associate of any said access by any said one or more secondary client user.

In some embodiments, various secondary client users can access systems/servers of the invention, where each secondary user may use different identifiers (e.g., numeric or alphanumeric) for a particular primary client user, whereby the servers/systems function to federalize/index all the different identifiers to a single identifier particular to the system/server of the invention. For example, different information posted onto a server of the invention for the same primary user but with different identifiers is automatically associated with the appropriate primary client user account. In one embodiment, a system/server comprises a Master Index of Identifiers associated to particular primary client users.

Another aspect of the invention is directed to a claims adjudication method, comprising: submitting a claim for payment to a server by a secondary client user, wherein said secondary client user is a payee, wherein said claim comprises a code corresponding to a service provided by said secondary client user to a primary client user, wherein said server comprises a resolver database comprising an index of codes corresponding to a medical procedure, diagnosis, prescription formularies or combination thereof; inputting one or more inputs that are compared by an identity verification subsystem on said server, wherein said inputs are compared to data comprised on a identity verification subsystem and if matched then said service provider is authorized for said submitting; adjudicating said code from said claim to a code from said index of codes to determine an amount of money that corresponds to said claim; exchanging of funds between said secondary client user and a bank account associated with said primary client user; and optionally submitting a notification of said exchange from a messaging subserver comprised on said server to said primary account holder.

In some embodiments a server is accessible via the Internet, an Intranet, an Extranet, a telephony system, an Earth orbiting satellite system, a wireless communications system, or a combination thereof. In one embodiment, identify verification inputs to said server are provided through an interface selected from the group consisting of telephone, portable communication device, computer, television, and a combination thereof.

In some embodiments identity verification inputs are through voice verification, biometric verification, PIN verification, sound recording verification, password, or a combination thereof.

In some embodiments, information (or content) posted to a primary user's account comprises editable or non-editable content. In some embodiments, editable content comprises medical information, financial information, or a combination thereof.

In one embodiment, at least one emergency responder is allowed access to said medical information without said identity verification.

In various embodiments, different levels of access are required to access an account, whereby the different levels comprise open access to verified requesters, access to verified requesters upon approval by said primary client, no access to verified requesters, or a combination thereof.

In one aspect of the invention, a primary client user sets different levels of access to said information. In another aspect, a primary client user designates one or more associate accounts linked with said primary client user. In one embodiment, at least one or more associate accounts gain access to said information by providing said identify verification input.

In one embodiment an identify verification is performed by voice recognition algorithm, voice pattern recognition software, keystroke recognition software, sound pattern recognition software, biometric pattern recognition algorithm, biometric pattern recognition software, or a combination thereof.

In some embodiments, one or more secondary client is selected from the group consisting of an individual, a group of individuals, a medical professional providers including clinicians, physicians, nurse practitioners, radiologists, anesthesiologist, psychologists, pharmacist, psychiatrists, dental hygienists, nurses, dentists, chiropractors, physical therapists, occupational therapists, speech pathologists, nutritionists, orthodontists, laboratory personnel, medical coders, diagnostic center personnel, emergency\ambulatory medical personnel, a hospital, a health care providing organization, an HMO, an insurance provider, a government agency, a financial institution, and a combination thereof.

In one embodiment, the information/content comprises a personal health record particular to a primary client user.

In one embodiment, the server comprises a file (e.g., computer readable medium) comprising a recording of said primary client's voice.

In some embodiments, identity verification comprises fingerprint recognition, iris recognition, retinal recognition, or a combination thereof.

In one embodiment, the server is linked to a health savings account belonging to said primary client.

In a further embodiment, the server facilitates a payment exchange between a health savings account and at least one of said one or more secondary client users.

In one embodiment, a primary client user designates at least two or more secondary client users to access said information.

In one aspect of the invention, a produce comprising a computer readable medium is provided comprising an executable software program recorded therein for providing a primary client user and one or more secondary client users access to information comprised in a central server database, wherein said software program provides a identity verification system for authorization of said access, whereby said authorization comprises verification of one or more inputs by said clients in order to authorize said access, wherein a messaging subsystem on said central server provides user to user communication, wherein said primary client designates which of said one or more secondary clients are allowed said access and wherein said communication optionally includes payment exchange between at least two accounts associated with said users.

In various embodiments of the invention, access comprises retrieving information, inputting information, viewing information, modifying information, or a combination thereof. In some embodiments, access comprises verification of one or more inputs which are verified before access, thus providing multiple layers of security. In some embodiments, multiple layers provide access to different groupings of said information. In one embodiment, different groupings of said information comprise editable files and non-editable files.

In one embodiment, information that is viewed, posted, edited, retrieved and/or printed, is medical data.

In various embodiments, one or more inputs comprise password, PIN, keyfob, biometrics, an emitted or detectable signal or a combination thereof. In some embodiments, biometrics comprises an iris scan, a fingerprint scan, a voice scan, or a combination thereof. In one embodiment, an emitted or detectable signal is RFI or electromagnetic energy.

In one embodiment, a central server database is further linked to one or more subsystems. In various embodiments, a server comprises a subserver that resolves CPT procedure codes, ICD-9 diagnosis codes, DRG diagnosis codes, SNOMED codes, prescription formularies, and contract payment schedules.

In some embodiments, one or more subsystems comprise at least one message subsystem or an ACH subsystem. In some embodiments, editable files comprise medical history nutrition, habits, exercise regimen, medication, race, height, weight, demographics, event log, allergies, testing results, diagnostics electronic living will, DNA profile, mental health information, health care encounters to include diagnosis and\or procedures or personal information contact information, address, work and occupation information, health savings account information, bank account information, authorized associate account information, or any combination thereof.

Examples of non-editable files include but are not limited to a DNA profile, medication history, lab reports/results, digital images, binary attachment files, research data or a combination thereof.

In various embodiments, a primary account is further associated with at least one associate account. In some embodiments, one or more secondary account holder comprises an individual (e.g., such as family member), a hospital, a research institution, an academic institution, an insurance provider, an employer, a non-profit organization, a physician, a community health provider, a pharmaceutical company, or a combination thereof.

In one aspect of the invention, a computer readable medium product comprising a software program recorded therein for providing client access to content files comprised in a central server database, wherein said software program provides a identity verification system for authorization of said client access and secured data exchange, whereby said client comprises a primary client and one or more secondary clients, wherein said primary client assigns access profiles for each of said one or more secondary clients, wherein said access profiles are associated with a designated access level, wherein said software program further comprises executable logic providing communication amongst said primary and said one or more secondary clients.

In one embodiment, wherein said client access comprises inputting, modifying, viewing or retrieving said content files. In one embodiment, a designated access level controls which of said content files are accessed.

In one embodiment, communication amongst primary and one or more secondary clients comprises a notification to said primary client reporting said client access.

In one embodiment, notification to a primary client and/or one or more secondary client is via internet connection, a portable communication device, a computer, a television, a telephone, ATM, network appliance or router, or a combination thereof.

In one embodiment, a subserver provides automatic claims adjudication between at least two of said secondary clients.

In some embodiments, a software program on a server of the invention allows for payment exchange between a primary account holder and one or more secondary account holder (secondary client). In one embodiment a subserver present on a server of the invention provides payment exchange amongst said one or more clients.

In one embodiment, claims adjudication comprises at least one of said secondary client submitting a request for payment to a second said secondary client for services rendered to said primary client.

In one embodiment, a server FIG. 1 comprises executable logic which provides payment exchange between at least two of said secondary clients.

In one embodiment, a server FIG. 1 comprises executable logic which provides payment exchange amongst said primary client and said at least two of said secondary clients. For example, the enables electronic funds transfer from a bank account.

In another aspect of the invention, a content exchange platform system that provides identity verification of one or more clients wherein said one or more clients utilize one or more interfaces to input security information into a identity verification subsystem comprised in a central server of a client-server architecture computer network, wherein said system comprises a server interface, wherein said one or more clients when authorized can access said content, wherein said content is grouped into one or more data categories, wherein each of said one or more data categories is associated with one or more security layer, whereby authorization through each of said one or more security layer enables access by said one or more authorized clients to each of said one or more associated data categories, wherein said one or more clients comprise a primary account holder and one or more secondary account holder, wherein said primary account holder designates which of said one or more secondary account holder is eligible for said access, and whereby said system provides secured content exchange by or amongst said one or more clients through a messaging subsystem.

In one embodiment, one or more clients comprise a primary account holder and an associate account holder linked to said primary account holder. In one embodiment, access to content associated with a primary client user comprises retrieving, inputting or modifying said content.

In one embodiment, the system comprises a verification subsystem is in communication with one or more interfaces to input information (e.g., security information) for verification. In one embodiment, input of such security information comprises password, PIN, keyfob, biometrics, detectable signal or a combination thereof.

In one embodiment, biometrics comprises iris scan, fingerprint scan, vein pattern recognition, face recognition, hand recognition, voice scan or a combination thereof.

In some embodiments, the system comprises a messaging subsystem FIG. 1 comprises email, phone, fax or SMS. In one embodiment, inputting content comprises said one or more client recording his/her voice to be stored on said central server, said messaging subsystem, or said verification subsystem, wherein said recording can be utilized in a voice scan providing said identity verification.

In one embodiment, the system comprises computer readable medium with a software program recorded thereon which directs said messaging subsystem to call said one or more client and initiating said voice scan to provide said identity verification.

In one embodiment, the system comprises a server interface which comprises an internet connection, a portable communication device, a computer, a television, a telephone, ATM, network appliance or router, or a combination thereof.

In one embodiment, the system comprises content exchange which includes payment of money exchanged between said one or more clients.

In one embodiment, a primary account holder is an individual.

In some embodiments, a service account holder is selected from a group consisting of a bank, an insurance carrier, a hospital, a pharmacy, a physician, a claims processor, a medical research institution, an employer, a clinic, pharmaceutical company, non-profit organization, faith-based organization, a government agency or a combination thereof.

In one embodiment, the system contains content which comprises client-editable and client-non-editable files. In one embodiment, client-editable files on the system comprise personal information

In various embodiments, client-non-editable files comprise lab reports, digital medical images, binary attachment files, research data, medical history medications, DNA information, or a combination thereof.

In one embodiment, a primary account holder or said service account holder further comprise one or more associate accounts. In some embodiments, associate accounts are configured to allow access to said one or more security layer corresponding to said one or more data categories.

In some embodiments, content comprises personal health records for said one or more client.

In one embodiment, at least one client is provided with a master authorization to provide access to said content. Examples of individuals granted master authorization may include first responders who are described herein. In some embodiments, a master authorization comprises a password, PIN, biometric or detectable signal.

In one embodiment, the system comprises a messaging subsystem which comprises a software program recorded thereon that is linked to a sound receiver and provides voice recognition, sound pattern recognition, sound frequency recognition, frequency estimation, Hidden Markov models, pattern matching algorithms or a combination thereof.

In one embodiment, the system comprises an identity and content management subsystem, an identity verification subsystem and a messaging subsystem linked to one or more input server interfaces.

In one aspect of the invention a business method is provided comprising; accessing medical records data specific for a primary client user, wherein said medical records data is present on a server architecture comprising a verification subsystem, a communication subsystem and a claims adjudication subserver, wherein said accessing comprises posting, editing or viewing data, and wherein said method further comprises said secondary client user submitting a request for payment which is processed by said claims adjudication subserver.

In one embodiment, the business method comprises a claims adjudication subserver processing said request for payment and executes electronic funds transfer from an account to said secondary account user's account.

In one embodiment, the business method comprises a communications subserver which may communicate to a primary or said secondary user via e-mail, phone, set top, text message or a combination thereof.

In one embodiment, the business method comprises a request for payment which is only processed after a secondary user's identity is verified via an identity verification subsystem.

In one embodiment, the business method comprises electronic funds transfer from a personal health savings account to one or more secondary client user's account. In some embodiments, identity verification is through voice recognition algorithm, voice pattern recognition software, keystroke recognition software, sound pattern recognition software, biometric pattern recognition algorithm, biometric pattern recognition software, or a combination thereof.

In one aspect of the invention, a server (also referred to herein as “server architecture”) FIG. 1 is provided comprising a identity transaction engine, a verification subsystem, a messaging subsystem, a identity verification database, a resolver database, a common data formatting computer executable logic which provides interoperability and cross-system communication. A primary user can access information on the server through the Web or various other clients (e.g., set top boxes, PDAs, mobile phone, ATM, network appliance, telephone, etc.). In various embodiments, the server architecture FIG. 1 is protected from any interface by one or more firewalls. In various embodiments, the messaging subsystem receives, processes and/or stores incoming/outgoing communications received via email, phone, personal digital device, network appliance, fax or a combination thereof.

In various embodiments, the verification subsystem compares incoming inputs with stored information individual to a particular client, where such inputs include but are not limited to PIN codes, passwords, finger scans, iris scans, keyfob or a combination thereof.

In one aspect, the system provides a method for accessing personal information comprising, storing such information on a system where the information is particular to an individual, allowing access to other parties to such information to be controlled by the individual, where the access can be through one or more interfaces, and where access is provided following identity verification.

As used herein, the terms “primary client user” and “primary user” are interchangeable and have the same meaning. As used herein, the terms “one or more secondary user” and “secondary user” are interchangeable and have the same meaning.

Examples of a primary user include but are not limited to a person, patient, a clinical study entrant, a medical research subject or an individual. Furthermore, a primary user may be a pet, livestock or horse owner or a breeder of horses, sheep, dogs, cats, birds or the such. In addition, a primary user may be a zoo operator. Generally, the systems/servers of the invention can incorporate files/content associated to any subject (e.g., medical records for a natural person or medical records for an animal/pet). Therefore, in various embodiments medical/health records for an animal can also be maintained on the server/system of the invention. In one embodiment, an associate account for a primary user can be established that contains files/records for an animal (e.g., pet or other animal).

Examples of secondary users include but are not limited to a business entity (e.g., insurance company, employer, medical professionals (e.g., veterinarian, veterinary clinic, veterinary hospital, clinician, physicians, dentists, nurses, nurse practitioners, radiologist, psychiatrists, psychologists, dental hygienists, chiropractors, physical therapists, occupational therapists, speech pathologists, nutritionists, orthodontists), hospital, health care providing organization, HMO, insurance provider, government agency, financial institution, pharmaceutical company, academic institution, non-governmental organization, Medicare/Medicaid, community health care provider or any combination thereof.

One aspect of the invention is directed to the type of account comprised on systems/servers of the invention. Thus in various embodiments, the primary client user registers an account comprising personal files/records on systems/servers of the invention include but are not limited to medical/health records, driver records, financial records, tax records, life insurance records, financial records, federal/state government-required registrations (e.g., business records, business registrations, employee with-holding tax accounts, use tax accounts, income tax accounts), investment accounts, or a combination thereof. Therefore, in various embodiments, a primary client user can designate various layers of access to files/content associated to one or more “account”, where an the term “account” in the context of this paragraph is interpreted to mean one of the foregoing records. Furthermore, “records”, “files”, “information” and “content” may be interchangeable as used herein.

In various embodiments, the information maintained on the server of the invention comprises, medical content specific to primary user, clinical data for a primary client user (e.g., clinical studies, or whole genome analysis using a primary client user's DNA) or personal information.

In one aspect of the invention, information comprised on the server comprises a personal health record (“PHR”) comprising content files which include but is not limited to: (a) past patient medical history, including treatment, illnesses, family history, past and current medications, and generally all content information known in the art as medical history. Such information/content also includes X-rays, CT scans, MRI scans, blood screens/test results, medical treatment information, medical conditions (e.g., current, past, pre-existing), allergies to medications, current medications or any other results, laboratory results/reports, digital images, binary attachments (e.g., PDF files), research data, DNA profile or genome information, test, screens, scans, which are known in the art. For example, any of the services or products classified under NEHITS can be maintained on the server database.

The content would include a medical history to the extent available and be capable of regular updating.

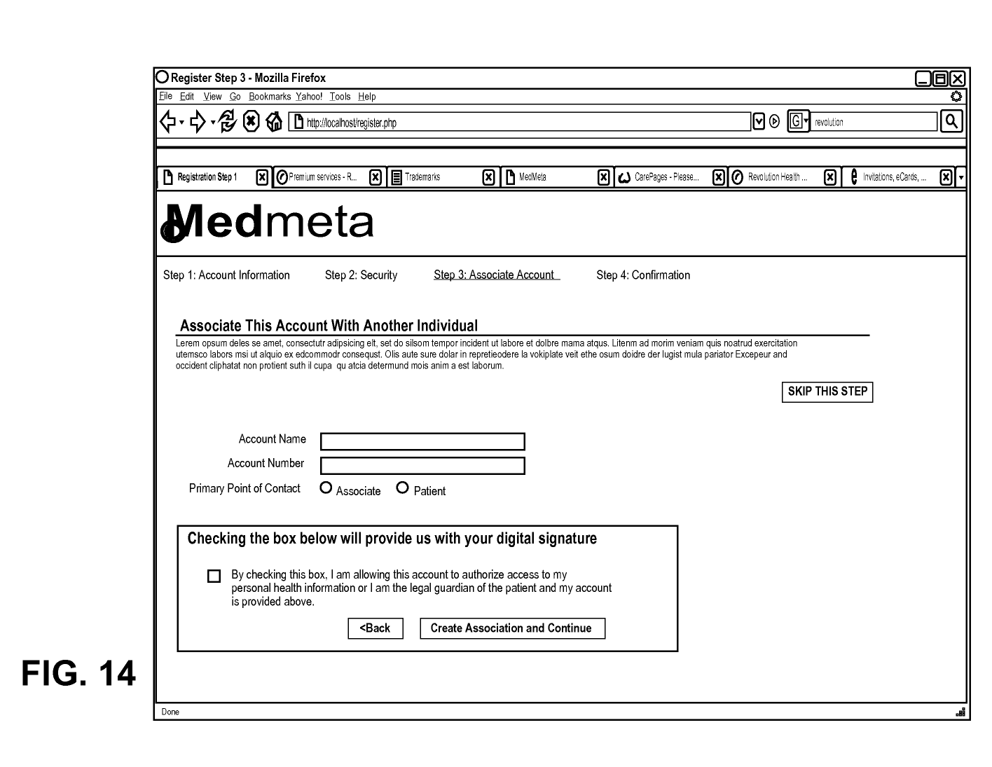

In some embodiments, a PHR will comprise designated primary user-editable content that is exclusively editable by the primary user. For example, client editable files may include “personal information” as described herein. In other embodiments, the editable information comprises primary user provided medical history information, comments/answers outlining or explaining the primary user's diet and/or exercise routines, history or log; as well as information regarding “associate accounts”. This information would be accessible to the primary client for any appropriate changes or updates as needed. In one example, a user can register for an associate account using a web portal FIG. 14.

Associate Accounts. In one aspect of the invention, “associate accounts” can be associated with a primary or a secondary user account. For example, for a primary user, associate accounts include but are not limited to a family member (e.g., children, parents, grandparents, siblings). These may represent individuals covered under the insurance plan or health savings account of the primary user.

In some embodiments, the associate accounts are established for a secondary user's agents, employees, claim processor, hospital staff, medical professionals' professional associates, or any combination thereof. These may be needed by an organization to provide access rights to various individuals in order to complete certain transactions. For example, the individuals maybe in technicians/administrators in a hospital or diagnostic laboratory or claims processors in an insurance company or health savings account company.

In some embodiments, content on the server is specific for a primary user's “personal information” which includes but is not limited to: (a) the name of an individual, address, social security number, age, birth date, height, weight, ethnicity; (b) name of an individual that is a guardian, parent, sibling or child of the individual; (c) name of a person in a caring relation to the user, whom the user wishes to be notified in the event of the user's illness, injury, or death and (c) contact information pertinent to the caring natural person; (d) information concerning participation by the user in any organ donor program; (e) health proxy and living will information, concerning scope of medical treatment desired by the user under severe medical circumstances; (e) the name of any person holding a health proxy of the user and contact information pertinent to such person; account information for the individual's health savings account (HSA) or personal health account, checking account, credit card or other financial institution account; and (f) health provider and health insurance information pertinent to the user. Some or all of such information may be included as desired based on individual circumstances for the primary user.

A “identity verification input” (“IVI”) of a user is an input capable of uniquely identifying the user, such as, for example, a password, a keyfob, a personal identification number (PIN), an RFI or electromagnetic signal emitter, and biometric identifiers, which include iris scan, fingerprint scan, vein pattern recognition, face recognition, hand recognition, voice scan, a sample of the user's DNA, or the sequence of a relevant portion of such a DNA sample. Any IVI that is capable of being stored in a digital storage medium that retains characteristics of the identifier to a degree sufficient to permit reasonably reliable discrimination between the user and another person. For example a digitized IVI can be a digitized photograph of the user's face, and the photograph may be manually or automatically compared with the face of a subject purporting to be the user. Any biometric identifier can be input by a user and compared by the identify verification subserver of the invention. Therefore, an identity verification and management system is provided to authorize access.

Identity verification systems of the type described in various embodiments herein may be employed in a wide range of circumstances, including not only medical records management, but also E-commerce, for example, distance learning and examination taking. In distance learning, the authentication system can be used to confirm actual attendance by persons purporting to be enrolled, and in examination taking, to confirm the authenticity of persons taking examinations. Thus, a system of the present type may be employed in any situation where a person is not physically present or is incapacitated, so normal in-person authentication is not possible or is difficult, and another party needs information about the person for the conduct of some transaction or matter.

In various embodiments, a multiplicity or plurality of interfaces or terminals by which a user inputs one or more inputs to verify identity of the user, thus to authorize access. A “multiplicity” or “plurality” of interfaces or terminals means at least three terminals. A IVI interface includes, for example, any device (such as a fingerprint reader or a voice terminal/analyzer) that transforms physical information, derived from a physiological feature of a human subject that is capable of uniquely identifying the subject, into computer-readable data useful for identifying the subject.

As described supra, an “account” registered on the systems/servers of the invention defines types of records/files stored on the servers of the invention. Regardless of the account type, the users can access the server to upload information regarding their account number and account information to arrange/authorize for future electronic funds transfers. Authorization for any such transaction is facilitated by computer executable logic for comparing IVIs by any user and the information present on the identity verification subsystem on the server. Thus, any IVI is compared to information comprised in the identity verification subsystem so as to authorize access to the server FIG. 1.

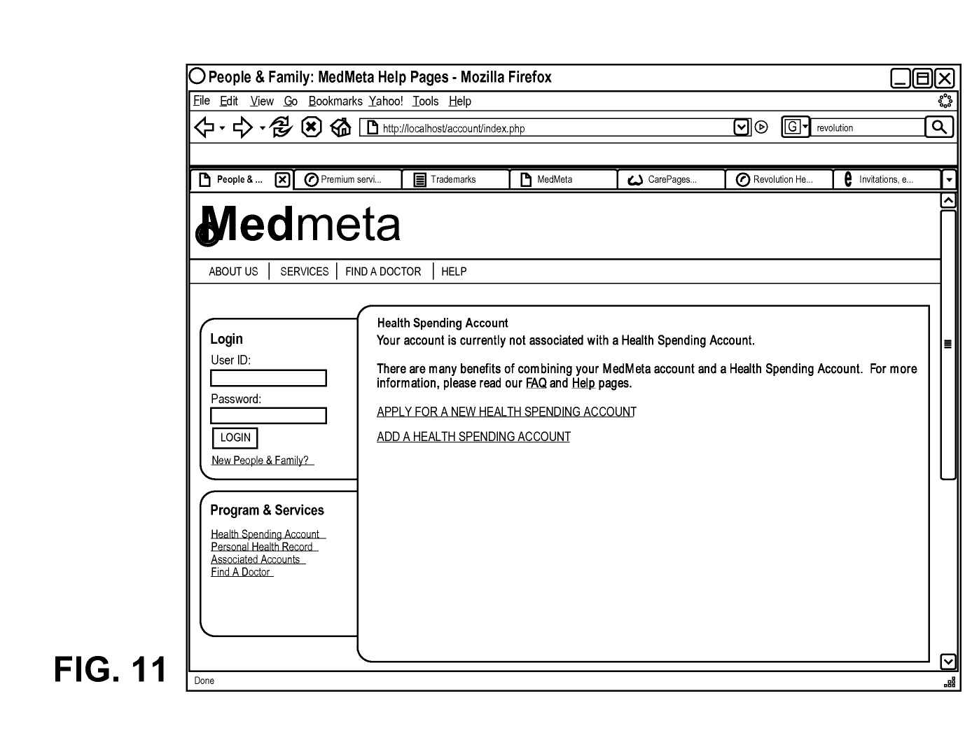

As used in various parts of the disclosure herein the term “account” is associated with a primary client user is one such as a personal or business checking account, a debit card account, a personal health savings account or a credit card account. (xi) Such an account can also be associated with a service provider or an insurer or underwriter that pays from such an account for services or products provided to the primary client user. Furthermore, exchange of funds can be into or out of such an account amongst a primary client user and one or more secondary account users. For examples, a health care provider can submit a claim to be paid out of the primary client user's account (e.g., personal health savings account) or out of the a secondary client user's account (e.g., primary user's insurance provider). It should be clear from the context of the use where the term “account” is associated with the type of files/records associated with a primary client user on servers/systems of the invention and in a different meaning the type of financial account involved in electronic funds transfers. For example, a user may register for an account type by accessing the web portal (e.g., register a health savings account FIG. 11).

As described herein, to conduct a transaction on the systems/servers of the invention, access is authorized by comparing IVIs with data present on the system/server of the invention.

In one embodiment, the primary user and one or more secondary users upload new content (e.g., files, data) particular to the primary client user. Furthermore, the information is subject to authentication and identity verification by one or more IVIs which a user must provide prior to access. Therefore, in various embodiments of the invention, the term “access” in this context means viewing, reviewing, downloading, modifying, editing, uploading, printing and/or transporting, whereby “transporting” means sending/receiving an attached file using the Web, landline, mobile, satellite, or hybrid land/satellite communication.

In various embodiments, content on the server particular to a primary user, is made available only on a selected basis to authorized parties and in accordance the appropriate context. In other words, a particular group of files or an individual file can be selected to be accessible by a particular secondary user and not by other secondary users. Furthermore, the such a selection categorization can be managed in cooperation with law enforcement agencies, where for example, the law requires that a particular file type (e.g., allergies to medication) always be available to a emergency responder (e.g., ambulance or ER technician). Furthermore, the identity verification subsystem and the identifying information stored on server will ensure only authorized users are allowed access to information on the server, thus precluding fraudulent use. Moreover, a messaging subsystem comprises computer executable logic which functions to send notices to a user when his/her information is accessed, using the various messaging embodiments disclosed herein (e.g., phone call, email, etc.).

The messaging subsystem comprises computer executable logic which functions to allow a user to designate any number or combination of messages/notices to be sent. Therefore, in some embodiments, a user can designate at which times or for which transactions a notice should be sent, and/or the types/numbers of notices to be sent. For example, in some embodiments, a primary user can designate that for any request for payment a notice is sent to the primary user via the messaging subsystem by 1, 2, 3, 4, 5, 6 or more different messaging systems FIG. 1. In one embodiment, messages are sent by e-mail and voicemail, for example. Or a secondary user can designate a notice to be sent whenever an associate account user accesses a primary account user's files/records.

In other embodiments, the messaging subsystem can comprise voice data files that can be accessed by the identity verification subsystem to compare an IVI input from a user seeking to access a file/record or seeking to conduct a transaction on servers/systems of the invention.

Multiple Security Layers

Therefore, in various embodiments, any request for information is challenged by a request for identifying information from the user through the one or more interfaces described herein. Access to the information is based on several layers of security, in that only certain users are designated/authorized for access, and furthermore, only certain content (file(s)) is designated/authorized for access for each of several different categories of users. For example, some files will automatically be transmitted whenever a request is submitted by the designated authorized user (e.g., allergies to medication requested by an ER physician). However, a primary user can “flag” any information, any content, any file, or any element of a file with a bypass flag, so that such data is available to designated users requesting information from the server.

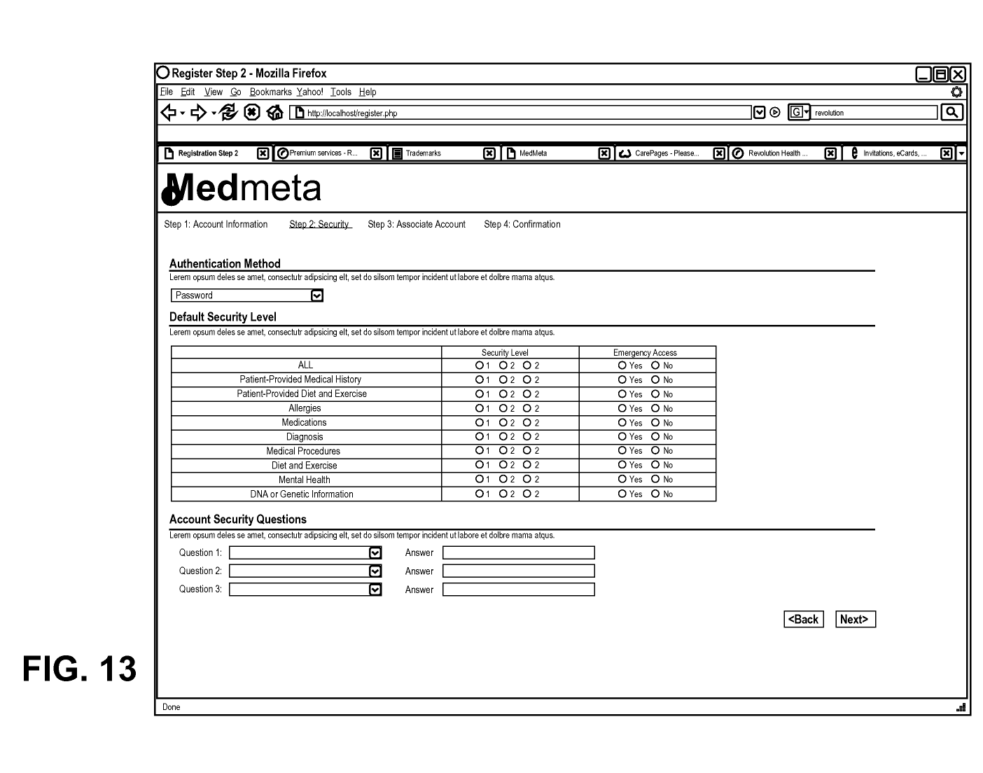

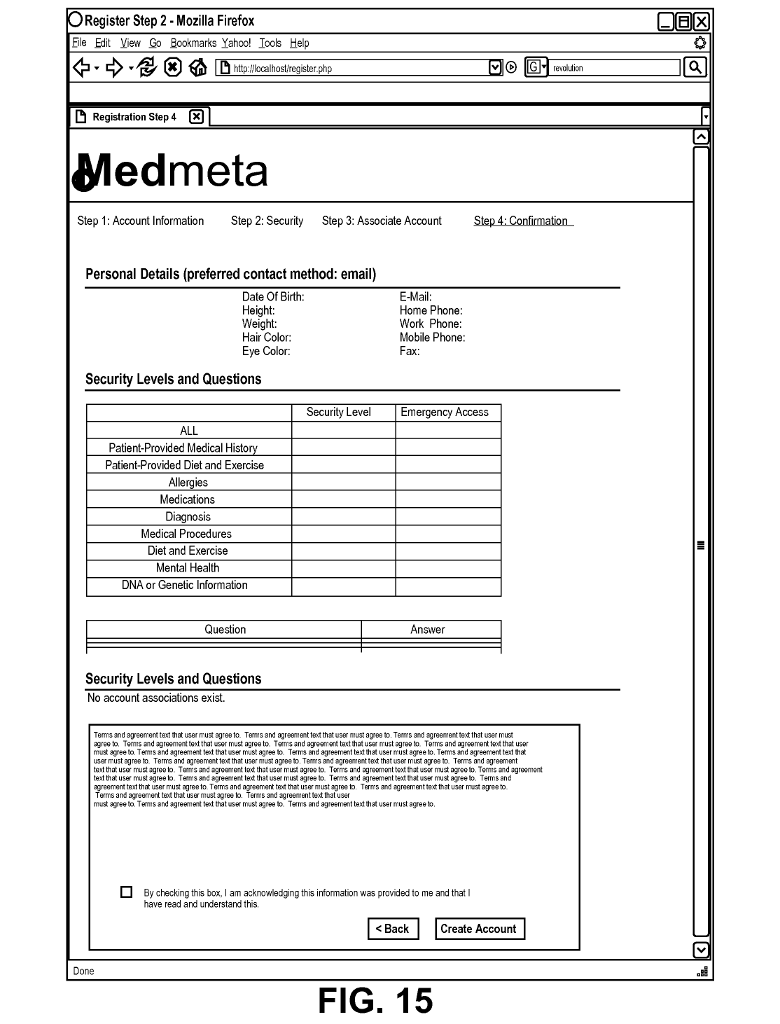

In one embodiment, a default security level is designated for certain sensitive content, files, file or element of a file (e.g., social security number will be protected as guarded information, including a prompt to the user asking if she is certain she wishes to change the security level). Therefore, can designate a certain security level for a particular type of content (e.g., personal information, financial information, insurance information, etc.) or more detailed designations over a particular file (e.g., genetic test results) or an element in a file (e.g., arrest in a driver's record/history). The key point is that the systems/servers of the invention comprise computer executable logic that functions to allow a user to designate different levels of access/security for various different information. Furthermore, a user can enter such designations using a web portal FIG. 13, FIG. 15.

For example, in various embodiments a primary client user determines that one primary client user can access one type/group of files particular to the primary client user, while another secondary user has access to the same or different type/group of files. Thus in some examples, a layer of security/access is defined by the type of files accessed (“F” for files) and another layer of security/access is defined by who can access particular type of file (“U” for user). A further layer of security/access comprises what action (“A” for action) can be done with a particular file (e.g., view, edit, post, etc). Thus for example, different layers of security/access can be F x U x A, or F x U, or another example is F x A, and another example is A x U.

Other files require additional identification verification (e.g., uploading/modifying a file comprising lab results, for example, for a primary user by her physician). Yet other files are guarded and unavailable (e.g., as designated by the primary user), such as a primary user's bank account number or social security number. Therefore, in one embodiment, the server architecture provides a three level control for one or more information files pertinent to a primary user.

In some aspects of the invention, a primary user designates which one or more secondary users can access the primary user's information, whereby such access is facilitated by identity verification through the identity verification subsystem 111 comprised on the server FIG. 1. In some cases, the primary user can designate one or more emergency responders so that such responders can access the medical or personal information of the primary user in an emergency situation. Furthermore, such access can be subject to subsequent review to ensure that it was appropriate. In some embodiments, any such access can be designated to trigger one or more notice/messages generated by the messaging subsystem of the invention, directed to the primary client user and/or a government agency or department (e.g., police, fire, emergency services, regulatory or oversight agency).

Emergency responders include but are not limited to a police, emergency medical technicians, ambulance technicians, emergency room physicians, nurses or technicians. In one embodiment, the primary user designates access to selected content (e.g., medical history, current medications, allergies, pre-existing medical conditions, contact information for the primary user, emergency contact for the primary user, or family member, etc.). In one embodiment, the information content is established and modifiable only by the user (or, optionally, by an associate user).

For example, in one embodiment, an emergency responder will input identify verification in order to access an individual's medical records by entering identifying information for the individual. The individual in this case would be a primary user whose information is stored on a database linked to the server/system of the invention. The emergency responder once authorized and once entering the primary user's identifying information, would gain access to certain files/records particular to the primary user. Such files can be designated or predetermined as files to which an emergency responder should generally have access (e.g., medication allergies, underlying medical conditions that can change diagnosis/prognosis, and any such information that is critical to provide emergency medical care).

The identity verification subsystem can be linked to one or more interfaces for entering a PIN, password, finger scan, iris scan, keyfob or a combination thereof 112 to 117.

As noted herein, one or more IVIs can be provided by a user to provide identifying characteristic of the user, i.e., capable of uniquely identifying the user. Various biometric identifiers and methods of utilizing such identifiers are known in the art and can be utilized to provide IVIs through system interfaces, as well as stored on one or more system databases; such identifying devices/methods are known in the art, such as in the relevant disclosures of U.S. Pat. Nos. 5,291,560; 5,016,282; 6,985,887; 6,507,912; 6,961,1448; 7,138,904; 7,154,375; 7,079,531; 7,121,471; 6,483,929; 6,930,707; 6,597,770; and 6,314,401 the disclosures of each of which are incorporated herein by reference in their entirety. See also the content, which is hereby incorporated herein by reference in its entirety, of the following web sites: www.biometrics.org (The Biometric Consortium), www.emory.edu/BUSINESS/et/biometric/(biometri-c technology explained at Emory University site), http://webusers.anet-stl- .com/.about.wrogers/biometrics/ (The Biometric Digest).

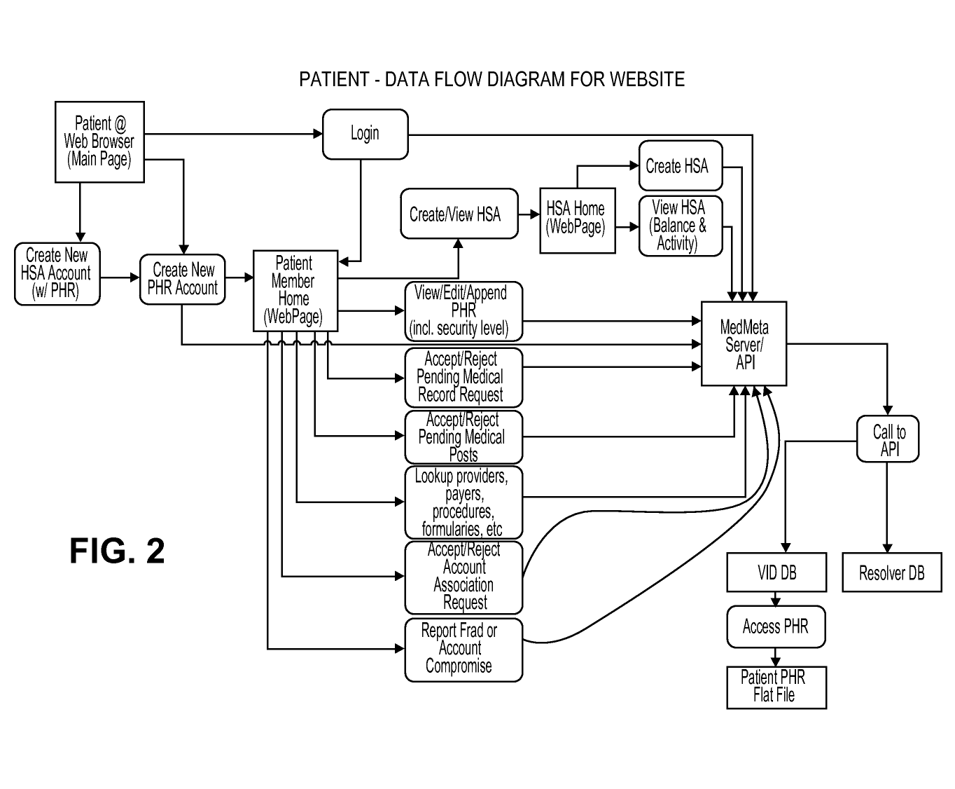

In one aspect of the invention, a primary user (e.g., patient) utilizes any interface (e.g., Web page browser) 200 to login into the server FIG. 2. The primary user can create a new health savings account (HSA) 201 and/or create a new personal health record (PHA) 202, whereby the primary user enters a member homepage 203. Subsequent access to the home page is effected through login 211 to the homepage 203. In various embodiments, the primary user can view edit/append her PHR 205 including designating different security levels for various content or files, accept/reject pending access requests 206, accept/reject pending uploads/modifications 207, review information about one or more secondary users (e.g., information about a service provider, institution specific procedures, formularies, etc.) 208, accept/reject account association requests 209 or report account fraud or compromise to the appropriate agency (e.g., police or fraud monitoring agency) 210. In one embodiment, the HSA account comprises a separate homepage 212 whereby a user can create an HSA 213 or view an previously created HSA 214 (e.g., balance, account activity). In various embodiments, the application programming interface on the server 215 provides a common data/programming interface for various data transactions conducted by a primary or secondary user(s). For example, in one embodiment, a user places a call 216 using a telephonic interface (e.g., phone, computer microphone) to provide a voice sample which is compared by computer executable logic on the identity verification subsystem to data for the user comprised on the identity verification database 218. For example, if a secondary user is a service provider whose identify if verified using the voice scan, then the patient provider can submit a claim for payment to the resolver database 217 which comprises computer executable logic to compare the coded claim to a code index comprised on the resolver database. In some embodiments, the user (e.g., primary or secondary), once authorized through identity verification 218 is authorized access to the PHR 219, 220.

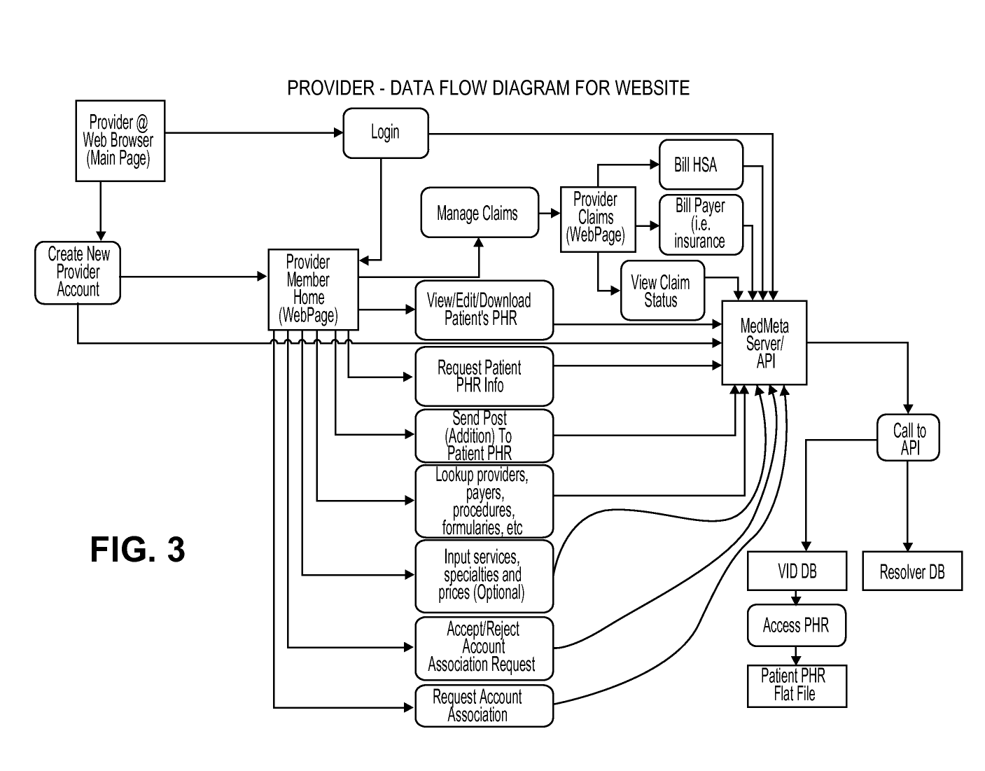

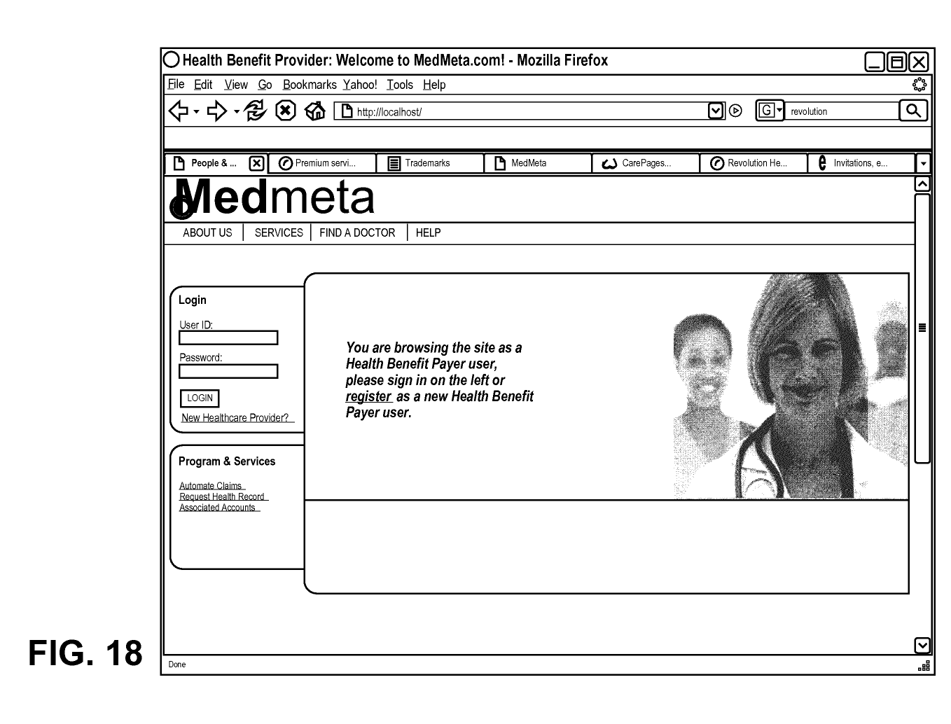

FIG. 3 shows a flow diagram where a provider (e.g., “secondary client user”, also referred to herein as “secondary client” or “secondary user”) can create a new account or login to an existing account. Once logged in or after creating a new account, the secondary user can access a home page (e.g., FIG. 18) where the user can select from a number of various transactions, including manage claims, view/edit/download a primary user's (e.g., patient) file(s), request information associated with a particular file (e.g., patient personal health record file(s)), send a post to the secondary user's file, or a primary user's file, review providers, payers, procedures, formularies, drugs, or any information available on the server, input services, specialties, prices or any information particular to the secondary user's account, accept/rejection an account association request, and/or request an account association.

In various embodiments, the secondary client can manage claims associated with one or more primary clients by conducting various transactions including but not limited to billing the primary client's health savings account (HSA), billing a payer (e.g., insurance carrier), and/or viewing a claim status. The server comprises a common application programming interface that allows seamless processing of request/posts or access of data comprised on the server.

In various embodiments, the application programming interface (API) 317 on the server provides a common data/programming interface for various data transactions conducted by a primary or secondary user(s). For example, in one embodiment, a user places a call 317 using a telephonic interface (e.g., phone, computer microphone) to provide a voice sample which is compared by computer executable logic on the identity verification subsystem to data for the user comprised on the identity verification database 319. For example, if a secondary user is a service provider whose identify if verified using the voice scan, then the patient provider can submit a claim for payment to the resolver database 318 which comprises computer executable logic to compare the coded claim to a code index comprised on the resolver database. In some embodiments, the user (e.g., primary or secondary), once authorized through identity verification 319 is authorized access to the PHR 320, 321.

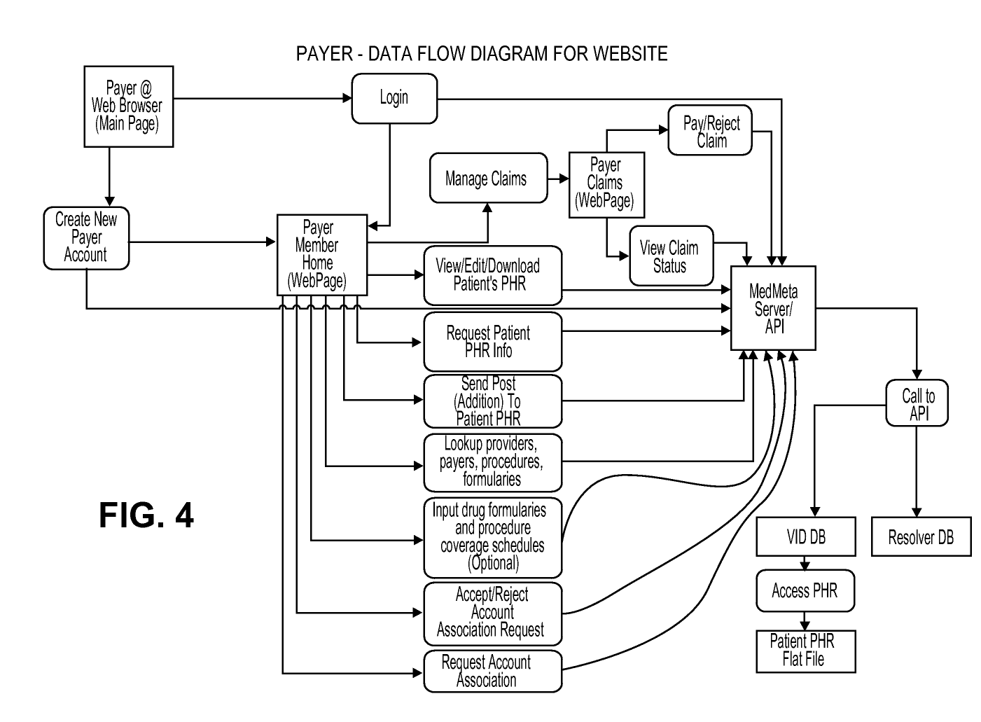

FIG. 4 shows a flow diagram where a payer (secondary client) accesses the server to conduct various transactions. Any transactions are mediated by the API facilitates data flow and program(s) execution allowing various transactions. For example, the secondary client can conduct transactions including but not limited to viewing/editing or downloading a primary client's file(s) (e.g., primary client's Personal Health Record (“PHR”)), requesting information associated with a primary client, sending posts (e.g., additions to patient's PHR), viewing providers, payers, procedures, formularies, accepting/rejecting account association requests, and/or requesting account association(s).

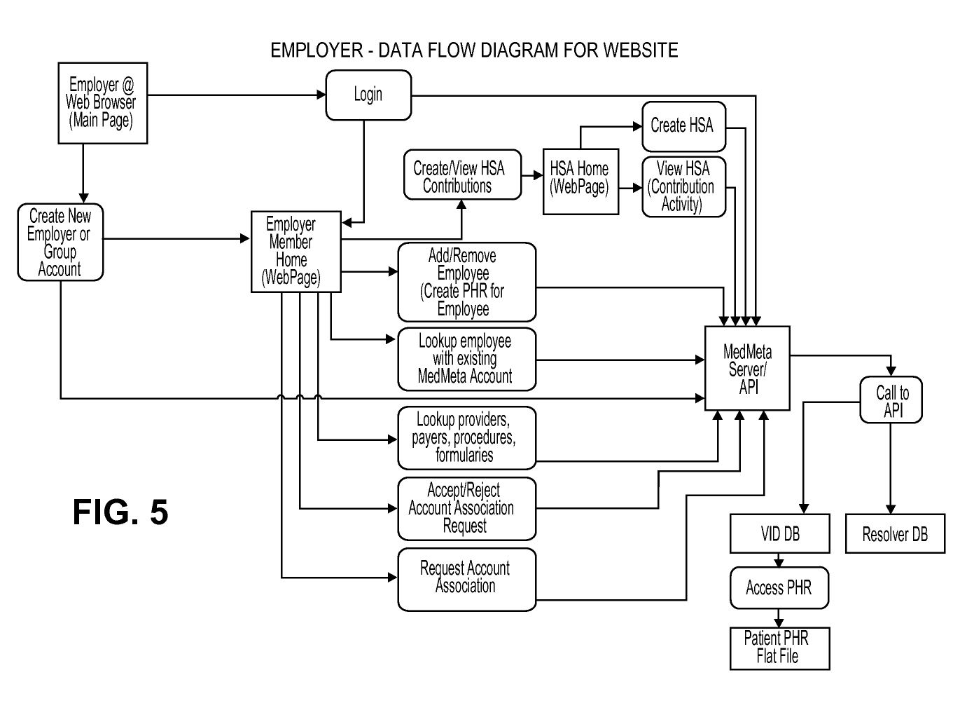

FIG. 5 shows a flow diagram where an employer (e.g., primary or secondary client) access/creates an account. Similarly to the examples described above, the employer can conduct various transactions, create/view HSA contributions from various employees, create HSAs, and/or view HSA contribution activities.

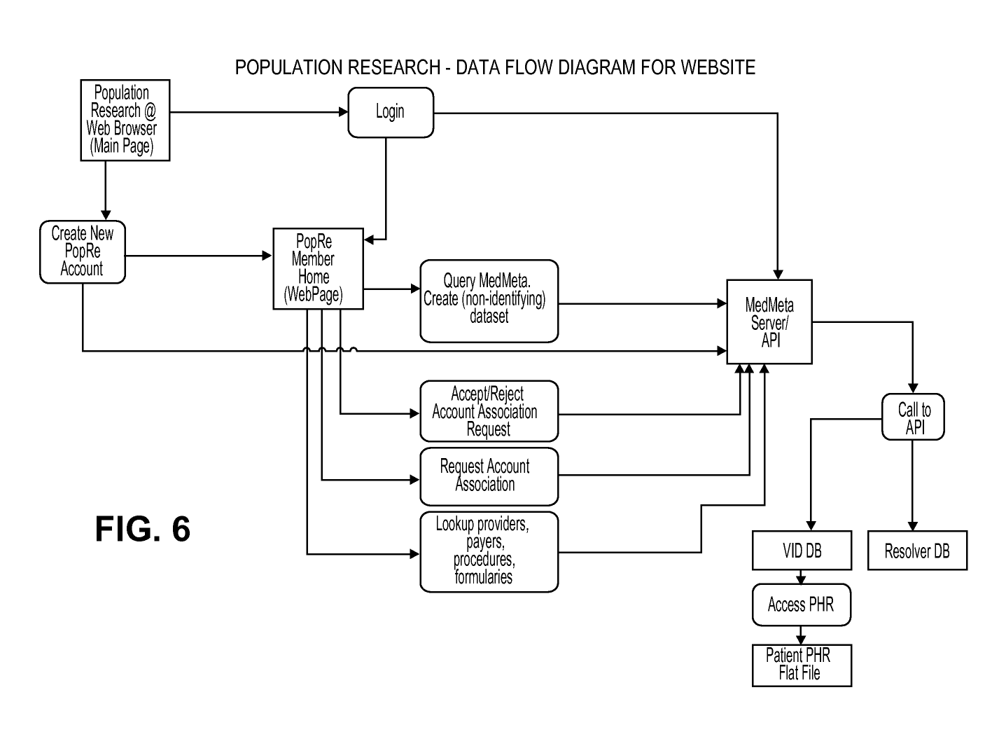

FIG. 6 shows a flow diagram for a secondary user (e.g., a researcher or clinic) who can access the server to conduct transactions including but not limited to creating a dataset for a plurality of subjects (primary clients) or for a single subject, accepting/rejecting association requests, requesting account association, and/or reviewing providers, payers, procedures or formularies.

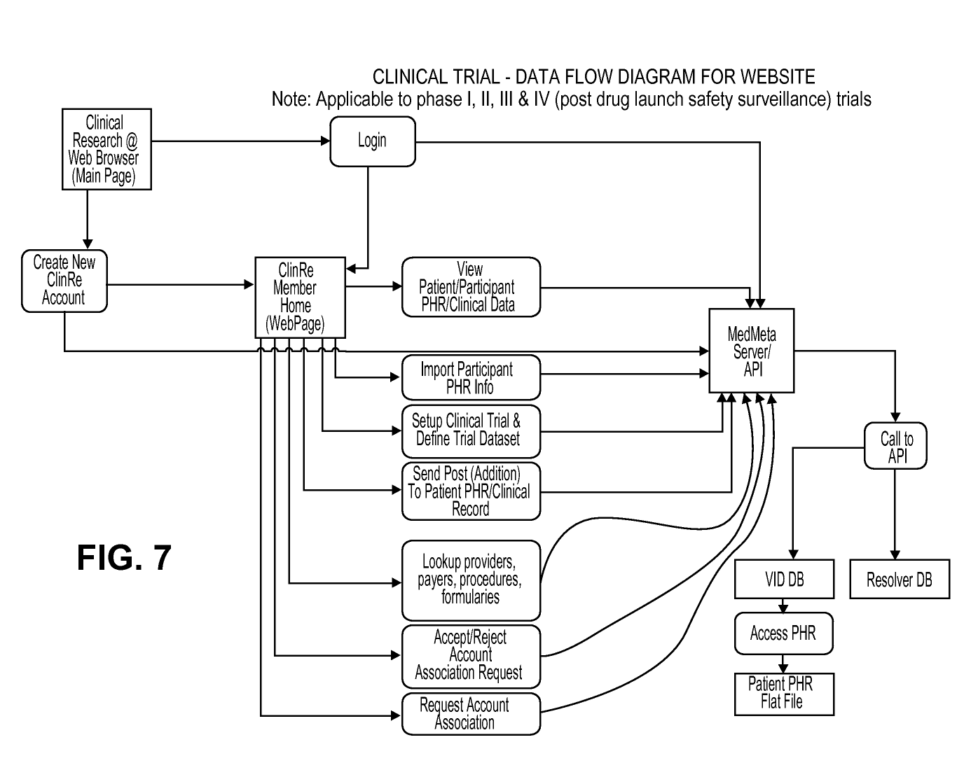

FIG. 7 shows a flow diagram for a secondary user (e.g., clinical researcher/institute) accessing the server to conduct transactions including but not limited to viewing clinical research participant's clinical data, import participant information, setup trial and datasets, posting additional data, accepting/rejecting account association requests and/or requesting account association.

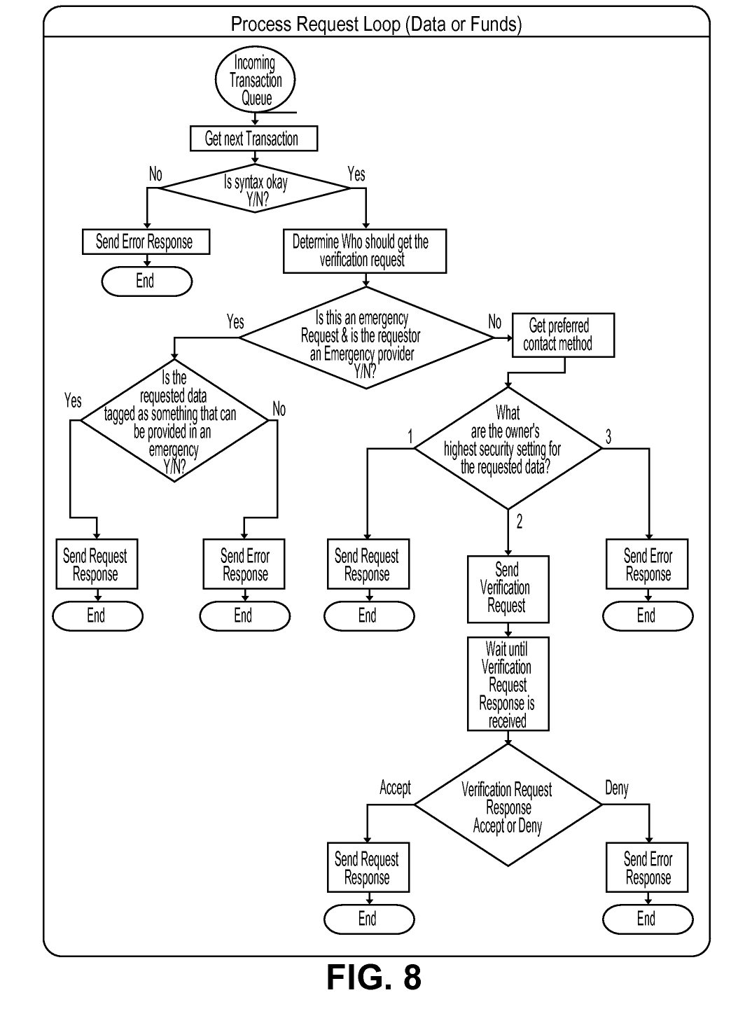

FIG. 8 shows a process request loop (e.g., for data or funds) where an incoming request is stored on the server of the invention in an incoming transactions queue, from which, a transaction is checked for syntax and if proper is checked to determine to whom the request should be directed. In one embodiment, it is determined whether the request is an emergency request and/or the requester is an emergency provider (e.g., first responder). In a further embodiment, it is determined whether the information requested is tagged as something that can be provided in an emergency. Furthermore, if emergency status is verified, it is determined what is the preferred contact method, by which a verification request is sent to the requestor. Once the requestor submits a verification response, it is compared to data stored on the server to accept or deny the request.

Federated ID Feature

In one embodiment, an identity features corresponds to Federation\Consolidation of MPI under the systems/servers of the invention (e.g., MedMeta server). For example, each secondary client user (e.g., provider's/physician's office) will have some type of identifier for each primary client user (e.g., patient), such as SSN or driver license number or photo i.d. number, or a field specific to software or a paper process the secondary client user utilizes. Therefore, each secondary user can enter or post information to a server/system of the invention particular to a primary user, but each secondary user may use different identifiers. The server/system of the invention comprises computer executable logic that functions to consolidate/federate the multiple different identifiers into a single master index. In other words, the primary client user is assigned a specific key, or mater patient index(MPI) so that a single identifier is assigned to a particular primary user on the system, and no matter the different number's of identifiers for the primary user utilized by different secondary users, any posting/access of information is channeled to the associated primary user. So each secondary client user can have the same or different MPI for a particular primary client user. For example, a health care provider will have an MPI for a given patient.

In one embodiment, the invention provides such secondary client users to provide their key so that their specific MPI is part of the record. In this way they may retrieve information by either their own MPI or by the ID provided by the server/systems of the invention. Each account could have many institutions MPI's attached (e.g., a patient's account on a Medmeta server can have different MPIs from various secondary client users, such as a hospital, private clinic, research institution). Therefore, consolidation of data (or federation of identity information) is facilitated efficiently.

In a preferred embodiment, secondary client users (e.g. providers or payers) are provided with an optional field for their MPI which can be utilized to identify a primary user for whom the secondary client user posts/access files, information or requests an electronic funds transfer transaction, for example. In the systems of the invention, such MPI entries are stored with the system ID of the provider. In a further embodiment, the MPI is also provided with the provider/payer number or index. Payers can put their own MPIs on PHR. By incorporating such MPIs in the main key of the existing systems of the invention and processes, the system “consumes” MPIs under the system ID so that the system ID becomes the identifier.

Voice Recognition Code

In non-limiting examples, the computer executable logic comprised on the server executes the following functions, to enable various embodiments for recording a voice sample on the identification database 110 for identity verification of a primary user, as well as secondary user:

File/Operation Message

1-MR_initiation1: Hello, the medical information voice response system would like to notify you that [user]

Playback <insert name>

2-MR_initiation2: has initiated your portable electronic personal health record. Please take a moment now to complete the setup of your account. This process takes approximately 5 minutes. You will need your Medmeta account number to activate your voice account. If you have your account number press 1 to start enrollment setup. If you do not have your number or would like to activate you account later, press 3.

Replay goto <replay9>

9 pressed return <MR_Initiation2>

Invalid entry Playback<invalid> return <MR_inititation1>

1 Pressed goto <Instructions>

3 Pressed goto <New_Account>

New_Account

51-to_activate To activate your Medmeta voice account, please call 304-212-4430 again that is 3-0-4-2-1-2-4-4-3-0. You can also go online and activate your Medmeta web account at Medmeta.com that is M-e-d-m-e-t-a.-c-o-m.

Goodbye playback<goodbye>

Replay goto <replay9>

9 pressed return <to_activiate>

304-212-4430 goto<Instructions>

304-212-4431 goto <Call_in_menu>

Instructions

52-instruct Welcome to the voice system enrollment. The enrollment process is completed in three easy steps. For the first step we will ask you to create a 4 digit pin. For the second step we will ask you to speak your name in order to enroll your voice into our recognition system. For the third and final step we will ask you to speak a sentence that will be replayed back to you every time you answer the phone. To start the enrollment process you will need your 15 digit account number. If you do not have your account number please press 3. To continue with the setup press 1.

Replay goto <replay9>

9 pressed return <instruct>

3 Pressed goto <Account_Number_Retrieval>

1 Pressed goto <Enter_Account_Number>

Account_Number_Retrieval

53-retrieval To retrieve your 15 digit account number you will be prompt to enter your area code, phone number, and name.

54-area_code Please enter your 5 digit area code followed by the pound key.

Replay goto <replay9>

9 pressed return <retrieval>

XXXX# record <area_code> goto<Phone>

Phone

55-phone_number Please enter your 10 digit phone number followed by the pound key.

Replay goto <replay9>

9 pressed return <phone_number>

XXXXXXXXXX# record <phone_number> goto<Alpha_Name>

Alpha_Name

56-alpha_name Please enter your name using the alphanumeric phone keypad followed by the bound key.

Replay goto <replay9>

9 pressed return <alpha_name>

XXXXXXXXXX-# record <name> goto<Play ID>

Play ID

57-ID_number Your Medmeta account number is

Play ID SayDigits<XXXXXXXXXXXXXXX>

58-restart Press 1 to continue to Medmeta voice system enrollment. Press 3 to exit

Enter_Account_Number

3-medmeta_ID: At the prompt please enter your 15 digit Medmeta ID account number followed by the pound key

Replay goto <replay9>

9 pressed return <MR_Initiation2>

Invalid entry Playback<invalid> return <MR_intitation1>

xxxxxxxxxxxxxxx# goto <Start Enrollment>

Start_Enrollment

4-welcome: Hello, and welcome to the Medmeta medical information voice response system, where you are in control of your medical records.

5-explanation: The Medmeta medical voice system will allow you to grant or deny access to your medical information securely over the phone.

6-enroll_start: Press 1 for new enrollment into the Medmeta medical voice system

Replay goto <replay9>

9 pressed return <exist_acc>

1 pressed goto <Enrollment>

Enrollment

7-pin_enroll: The first step in activating your Medmeta account is to create a new 4 digit pin number. Your new Medmeta voice system pin number is used as the first verification of your Medmeta account. Press 1 to start your pin setup.

Replay goto <replay9>

9 Pressed return <pin_enroll>

1 Pressed goto <Pin Enrollment>

Pin_Enrollment

8-pin_save: Please enter a four digit pin followed by the pound key that is easy for you to remember.

Read <xxxx#>

9-pin: Thank you your pin number is

Playback <xxxx#> goto<Voice Enrollment>

Invalid pin Playback<invalid> return <pin_save>

Timeout return <pin_save>

Voice_Enrollment

10-enroll: Protecting customer personal information is MedMeta's number one priority. To protect against unauthorized access to your account the Medmeta voice system setup will ask you to speak your entire name after entering your pin for voice verification. To proceed with the voice system enrollment please press 1

Replay goto <replay9>

9 pressed return <enroll>

1 pressed goto <Start_Voice>

Start_Voice

11-name: For voice verification enrollment we will ask you to speak your full name 3 times. In order to identify you correctly we need you to state your entire name, for example state John Alan Doe into your phone. If you are ready to begin the voice system enrollment please press 1

Replay goto <replay9>

9 pressed return <name>

1 pressed goto <Step One>

Step_One

12-name 1m: For the first voice recording please state your entire name at the sound of the beep. When finished press the pound key.

Record <name1>

Playback <name1>

13-name_redo1: If your voice recording was acceptable press 1. Press 3 to rerecord your name

3 pressed return <name1m>

1 pressed goto <Step Two>

Step_Two

14-name2m: For the second voice recording please state your entire name at the sound of the beep. When finished press the pound key.

Record <name2>

Playback <name2>

15-name_redo2: If your voice recording was acceptable and sounds similar to the first voice recording press 1. Press 3 to rerecord your name

3 pressed return <name2m>

1pressed goto <Step Three>

Step_Three

16-name3m: For the third voice recording please state your entire name at the sound of the beep.

When finished press the pound key.

Record <name3>

Playback <name3>

17-name_redo3: If your voice recording was acceptable and sounds similar to the first recording press 1. Press 3 to rerecord your name

3 pressed return <name3m>

1 pressed goto <Voice_Verify>

Voice_Verify

en-voice-verify compute voice metrics

18-en_verify_succ: You have successfully enrolled your voice name

goto <Self Recording>

19-en_verify_fail: Your voice name enrollment was not successful. Please repeat the enrollment and make sure that you state your entire name exactly the same in all 3 enrollment steps.

goto <Start_Voice>

Self_Recording

20-self_record: Hearing your own voice of a recorded message played back protects against scams that try to obtain your account information. Every time you verify your voice with medmeta's voice verification you will hear your recorded voice message played back to you. If you are ready to record a sentence of your voice press 1.

Replay play <replay9>

9 pressed return <self_record>

1 pressed goto <Start Self>

Start Self

21-self_enroll: At the sound of the beep please state any sentence made up of at least 4 words, and press the pound key when finished.

Record <self>

Playback <self>

22-self_check: If your recorded message is acceptable please press 2. If you would like to rerecord your secure voice sentence please press 3.

Replay play <replay9>

9 pressed return <self_check>

3 pressed return <self_enroll>

2 pressed goto <Finish_Self>

Finish_Self

23-self_finish Every time you complete voice verification with the Medmeta system. You will hear this recorded message played back to you. If at anytime you do not hear this message please reset your pin and contact us at 304-212-4430. Press one to complete Medmeta's voice enrollment.

Replay play <replay9>

9 pressed return <self_record>

1 pressed goto<success>

24-success: Your Medmeta voice system has now been activated. When new information is added to your Medmeta medical account or a doctor would like to retrieve information from your account you will be notified with a phone call. You can also go online and activate your Medmeta web account at Medmeta.com that is M-e-d-m-e-t-a.-c-o-m.

Goodbye play <goodbye>

Medical_Record_Access_Request

Call out <Medmeta Verify>

25-access1: The Medmeta medical information voice system would like to notify you that

Playback <insert name>

26-access2: would like to access your medical record information. Press 1 to allow access to your information press 2 to deny access to your medical record information.

Press 1

27-allow: You have allowed access to your medical record information,

Thank You and Goodbye.

Press 2

28-deny1: You have denied access to your medical information. Please contact

Playback <insert name>

Playback <at>

Playback <phone number>

Playback <goodbye>

Invalid entry Playback<invalid> return <access1>

Medical_Record_Update

Call out goto <Medmeta Verify>

29-update1: The Medmeta medical information voice system would like to notify you that

Playback <insert name>

30-update2: has updated your medical record files. To view updated files please logon to your Medmeta account at MedMeta.com

Playback <goodbye>

Checkup_Notification

31-check_note1: Hello, the Medmeta medical information voice system would like to remind you that

Playback <insert name>

32-check_note2: has an appointment to meet

Playback <insert name>

Playback <on>

Playback <insert date>

Playback <at>

Playback <insert time>

33-check_note3: This message was brought to you buy the Medmeta medical information system. To access your medical information online please go to Medmeta.com and setup an account.

Messages

34-goodbye: Thank you and Goodbye

35-at: At

36-on: On

37-invalid: You have entered an invalid entry

38-replay9 Press 9 to replay this message

Medmeta_Verify

39-notify Hello, The Medmeta medical information system has a notification for you. To access this notification verify your identity by entering your pin number followed by the pound key

xxxx#

Invalid pin Playback <invalid> return<notify>

40-name_enter Please state your full name after the beep followed by the pound key.

Record <member_name>

voice-verify compute voice metrics

verify success goto <verify _succ>

verify failure return <verify_fail>

41-verify_fail: Your voice name did not match the enrolled name. Press 1 to try again

1 Pressed goto <name enter>

42-verify_succ: Your voice has been verified. Retrieving your secure message

Play self playback<self>

50-self_note Every time you complete your voice verification with the Medmeta system you should hear this recorded message played back to you. If at anytime you do not hear this message please reset your pin and contact us at 304-212-4430.

43-thank_warning: Thank you for verifying your pin and name. If the sentence that was just replayed was not your voice or you do not hear your recorded voice sentence, please reset your pin number and contact us at 304-212-4430.

Call_in_Menu

Welcome Message Playback<welcome>

44-account_enter To access your Medmeta account please enter your 15 digit Medmeta ID account number followed by the pound key.

Replay goto <replay9>

9 pressed return <MR_Initiation2>

xxxxxxxxxxxxxxx# goto <menu>

45-menuPress 1 to reset your Medmeta pin number, Press 2 to speak with customer assistance.

1 Pressed goto <Pin-Reset>

Pin_Reset

Playback <name_enter>

Record <member-name>

voice-verify compute voice metrics

verify success goto <verify_succ>

verify failure return <verify_fail>

47-verify_fail: Your voice name did not match the enrolled name. Press 1 to try again

1 Pressed goto <name enter>

48-verify_succ: Your voice has been verified. Retrieving your secure message

Play self playback<self>

49-pin_save: Please enter a four digit pin followed by the pound key that is easy for you to remember.

Record <xxxx#>

9-pin: Thank you. Your pin number is

Playback <xxxx#> goto<Call in Menu-account_enter>

Invalid pin Playback<invalid> return <pin reset>

Timeout return <pin_reset>

In various embodiments, a user is required to authenticate a transaction being made with the server. In this connection, the user may utilize any of system interfaces described herein (e.g., either a fingerprint reader or a voice terminal/analyzer, or both of them, from which may be derived a test set of physiological identifiers). The identify verification subsystem is then used to retrieve physiological identifier data stored as part of the user's data set in the identify verification (FIG. 1, 111, 110) database and then to determine whether data from the test set of physiological identifiers sufficiently matches the corresponding retrieved data. The results of the match determination can be communicated to the user through the messaging subsystem 114.

In some embodiments, although the identity verification subsystem 111 is shown in FIG. 1 as part of the server architecture, it may in fact be located remotely from the terminal over a suitable network, and may be conveniently located at the same network node. Furthermore, data from any of one or more IVI interfaces 112 to 117 in FIG. 1 may be transmitted over the network to the remotely located identity verification subsystem for the sufficiency of the match with the corresponding retrieved data from the VID database 110.

In various other embodiments, any subsystem or database comprised in the server architecture of FIG. 1 can remotely hook into the server and may themselves be composed on a distinct server.

For example, as described herein above, voice scans can be utilized for identity verification and conducting transactions on the server, wherein computer executable logic comprised on the server functions to send and receive voice prompts to a user, analyze the voice prompts and execute the ascribed function (e.g., in lieu of pressing a number on a telephone or PDA device). In one embodiment, the use of an utterance for authentication may be accomplished over a telephone without the need for the user to go to a different physical location. It is possible to store data pertaining to a plurality of physiological identifiers, and, with respect to a given transaction or circumstance, to select an identifier for authentication purposes that offers a desired trade-off between convenience and reliability. In other words, the use of a plurality of physiological identifiers permits adjustment of the reliability of the physiological identifier (by selecting the appropriate type of identifier) to suit a desired level of reliability.

As noted supra, an identity verification system of the type described in various embodiments may be employed in a wide range of circumstances, including not only medical records management, but also E-commerce, for example, distance learning and examination taking. In distance learning, the authentication system can be used to confirm actual attendance by persons purporting to be enrolled, and in examination taking, to confirm the authenticity of persons taking examinations. Thus, a system of the present type may be employed in any situation where a person is not physically present or is incapacitated, so normal in-person authentication is not possible or is difficult, and another party needs information about the person for the conduct of some transaction or matter.

The use of the various embodiments described above can reduce the risk of identity theft, because a merchant, intending to rely on the implicit representation that a subject is the one who the subject purports to be, now has the benefit of a physiological identifier (as opposed to merely a password, etc., which may be stolen) confirming the subject's authenticity. Moreover, in a case where identity has already be stolen and a fraud perpetrated, a victim who has previously established a user data record in a multi-user personal information data base of the type described above may utilize the information in the user data record to reestablish identity with one or more merchants. Indeed, an imposter who seeks to steal the identity of a user having a data record that is registered in the multi-user database, under circumstances where a reliable physiological identifier is employed to authenticate a transaction, must risk giving a fingerprint, for example, to the organization managing the multi-user database. Because the imposter's fingerprint may then be accessed by law enforcement officials, for example, using normal warrant procedures, the chances of successful fraud are significantly reduced and a significant deterrent to fraud is also provided.

In some embodiments, the identity verification comprises a card or other token to indicate that the user has provided a IVI information to the applicable multi-user database and even to identify in some manner (for example, by record number or a suitable alphanumeric identifier, as described above) the particular data record applicable to the user's medical information. (Similarly, such an identifier may confirm to a primary user that the user's personal information has been stored in the database, as well as to facilitate look up of data in the data base.)

A health care provider may then use information about the user to access pertinent medical information of the user. In this fashion, for example, the health care provider can have information permitting persons in a caring relationship to the user to be notified, and health care providers may be informed of information affecting treatment of the user. Current information about the status of the user's regular health care provider and health insurance may also be provided in this manner.

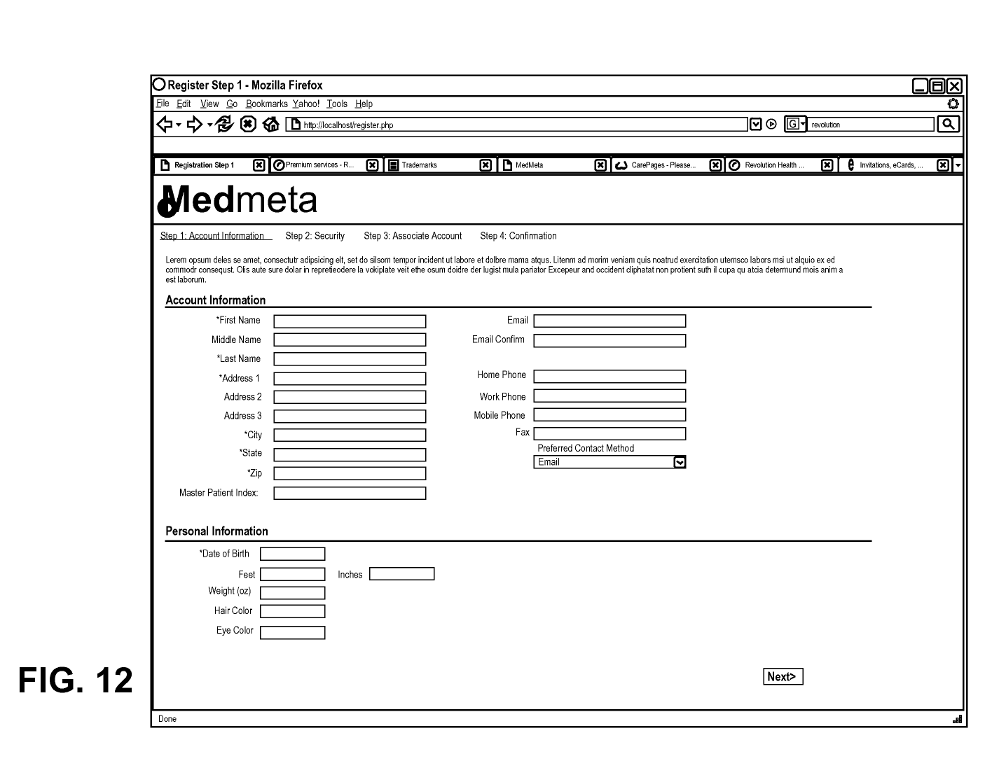

In implementing various embodiments described above, it is desirable for the manager of the server architecture and databases therein to prompt the user on a periodic basis, for example yearly, for an update of the user's personal information and medical information. For example, a user may enter or update personal information such as through a web portal FIG. 12.

When updated information is received, the data set of the user can be modified when appropriate authentication, as described, for example, in connection with FIG. 1, has been obtained from the user. Furthermore, as described above, certain files or elements within files are designated to be non-editable except by a particular user. However, as noted above regarding different layers of access, primary user or secondary user information for that matter, can be designated to be automatically sent via the messaging subsystem to other users linked to the primary or secondary user's account (e.g., notifying them of a change of address, change of phone number, or change in billing procedures, etc.). Given the inherent reliability of a database administered in this manner, it is within the scope of embodiments of the present invention to permit the messaging subsystem, utilizing computer executable logic to facilitate such automatic notifications.

An institution such as a bank, in cooperation with the sponsor of a data base administered in accordance with various embodiments described above, may offer a service, to protect a user, in which a user requires authentication, via use of the data base, of any request for tender of monies over a certain amount. Thus in such an embodiment, the primary user's HSA or other financial account is linked to the server architecture and to the one or more payees designated as authorized parties to submit a claim for payment, but is afforded an additional layer of security (e.g., notification sent to primary user of the tender for payment, requiring the primary user authorize the payment). One benefit of the system of the invention is that in various embodiments directed to various transactions, notification to a user and execution of authorized transactions by a user is conducted in real time, substantially real time or as limited by the communication network (e.g., signal availability for telephony, speed of email, etc.)

In one aspect of the invention, all data entered onto the server will be protected through encryption and firewall 112, 116, 119 in FIG. 1. The system FIG. 1 meets all privacy codes and federal regulations for securing and transporting health care information about private individuals. Because the access to the server, and the health care data contained on the serve are at a central location, the medical data are more secure than if they were transferred by hard copy or contained on a computer chip carried on the person of the patient. In addition, the central server databases are physically protected by infrastructure an personnel.

In various embodiments, disclosed herein, the information can be presented in a convenient form for the users, e.g., HTML or PDF, or another convenient file format. The system also offers email alert features: The patient can program e-mail reminders to appear for every doctor's appointment, prescription refill or renewal, and other medical incidents that may be important to health care.

The system of this invention may be especially beneficial for at-risk patients, disease management patients, students entering colleges, or persons studying abroad or stationed or traveling abroad. Such individuals can designate change, add or delete various secondary users for designated access to the individual's system content as necessary, for time specific events or durations, and for special events (e.g., traveling abroad). In other embodiments, administrators at HMOs, retirement homes, or universities may distribute the access cards or necessary IVIs to persons enrolled in their programs and facilities.

The system of this invention reverses some of the reasons for poor patient care that have plagued the health care community. By providing each treating physician with current medical history and health care data for the patient, the physician will have knowledge of any prior conditions, any possible allergic reaction or pharmaceutical contraindication. In addition, because records of all prior diagnoses and testing are maintained, the incidence of redundant and unnecessary testing and lab work will be reduced or eliminated. The physician will also see the treatment notes and procedures made by other health care practitioners. The physicians will be freed from much of time demands now made by required documentation, and this will provide more time for spending with the patient. The system also give the patient access to his or her own charts, and allows the patient to check on prescription information, upcoming visits, and other medical data that may affect him or her.

NEHITS

In some embodiments of the invention, an index of codes is provided, wherein each corresponds to a particular medical service or pharmaceutical formulary, wherein each code corresponds to a particular sum/fee. This index is referred to herein as “NEHITS”. The term “medical service” includes any medical procedure, doctor's visit, laboratory tests, medical procedure, or any such related service that would be provided to an individual.

NEHITS is largely based on the NIST ITL 1-2007 Data Exchange format for Fingerprints Scars Marks and Tattoos. NIST ITL 2007 serves as the basis for specifications used in law enforcement and identity vetting applications worldwide. Such examples include the Electronic Fingerprint Transmission Specification used by the FBI, the Electronic Biometrics Transmission Specification used by the DoD, and the Interpol ITL implementation used by Interpol. This standard is used as the common language to allow the FBI, DoD, DHS, and the DoS to exchange information when necessary and appropriate. The format allows for contextual data as well as image data to be combined into a single file for a single use.

Although there are many similarities, there are major differences between NEHITS and the “law enforcement style” specifications. Namely NEHITS is used for the exchange of medical information, identity verification, authorization of data exchange, and payment processing whereas the law enforcement is used for criminal processing and personnel processing. NEHITS is not intended to be used by law enforcement, but is well suited for Health & Human Resources (HHS), Center for Disease Control, Medicare\Medicaid applications and research (i.e. clinical trials and/or population research). Both styles, however, are transactional identity-based platforms. By using an existing standard already in use by all 50 states and large sections of the federal government, the NEHITS steering group seeks to create a common, cost-efficient approach to identity-based applications. Also, reference implantations exist for ITL-2007 and commercial software development kits can be obtained for easily read/writing transactions. These combined factors made the ITL-2007 an ideal starting point for providing a simplified, monolithic, approach for data exchange.

Health Care Improvement—The systems/servers of the invention can obtain benefits such as decreased administrative costs of health care, thus making health are less expensive. Furthermore, benefits include promotion of transparency of health care costs and outcomes.

Accessibility—This specification is free to download, free to use, free to distribute and modify in any way. There is no fee to obtain a copy of the specification. Although copyrighted by vIDentity Systems, Inc. NEHITS is distributed under the BSD license. All an implementer/or user is required to do is post a message that they are using the specification in their application or software.

Incorporation of existing standards work: NEHITS recognizes and applauds the continued work by ANSI, HL7, HITSP, X12, and AHIC. These formats, and others, can be inserted inside a NEHITS transaction can act as an envelope for these data formats.

Simplicity and Monolithic Approach—NEHITS seeks to be unambiguous. The only one way to say it creates an interoperable system

Patient Empowerment: Providing a patient with the right to control access to his or her medical information is central to NEHITS philosophy. Providing patient's a way to share the ability to grant access, such as a close relative, is also central. Each data element contains a patient-controlled level of sensitivity and a flag to grant authorization bypass to emergency responders in emergency situations.

Health Care Cost Transparency: NEHITS advantage

Technical Objectives

In one embodiment, incorporation of NEHITS into methods and systems of the invention provides a streamlined creation of personal health record and medical billing into a single process.

In one embodiment, incorporation of NEHITS into methods and systems of the invention provides a consumer-driver patient-controlled personal health record. In one embodiment, incorporation of NEHITS into methods and systems of the invention provides the privacy of the patient by requiring the patient's or the patient's guardian-authorization for access to medical information. Furthermore, incorporation of NEHITS into methods and systems of the invention provides a common framework for procedure-based and diagnosis-based billing/reimbursement In addition, incorporation of NEHITS into methods and systems of the invention facilitates the automatic adjudication of most claims between providers and payers. To process payments, in an electronic, paperless fashion, between a provider and a patient's Health Savings Account (HSA). Therefore, incorporation of NEHITS into methods and systems of the invention facilitates the administration of clinical trials, particularly stage III and stage IV trials.

In one embodiment, incorporation of NEHITS into methods and systems of the invention facilitate the administration of population research (also sometimes referred to as surveillance.)

In addition, incorporation of NEHITS into methods and systems of the invention provides a framework for academic research and create an invaluable data set to improve the health of human beings. Therefore, NEHITS provides an interface for medmeta.com, a novel internet-based software service which connects patients, health care providers, insurance companies, government, pharmaceutical manufactures, academia, and research organizations.

Users include primary client In one embodiment the primary client user is a patient (e.g., Medical Patients).

Moreover, various secondary client users are providers who access the network. For example, there can be 2, 3, 4, 5, 6, 7, 8, 9 or 10 or more types of provider users who access records/files for a single primary user. In further embodiments, the number of registrants that can be designated by a primary user is not limited (i.e., the system can accommodate a plurality of users both primary and secondary based on increasing server capacity, e.g., 100 s of thousands, millions, tens of millions, hundreds of millions of users).

In one embodiment, the provider comprises Emergency MedicalCare (EMC), such as in Emergency Rooms, Ambulances, Fire Departments, Police Departments or any combination thereof. In one embodiment, the provider is any first responder.

In some embodiments, the provider is any medical practitioner, such as doctors, Private Practices, Public/Non-profit Practices, Small/Free Clinics or any combination thereof.

In one embodiment, the secondary client user comprises Enterprise Care, Hospitals, Government Care, InfoCare, Laboratories/Diagnostics, Radiology/X-ray/MRI Centers.

In one embodiment, a secondary client user PharmCare, Pharmacies, Free/Government Clinics or a combination thereof.

In one aspect of the invention, various Payers access the network. In some embodiments, payers comprise medical insurers (e.g., MedInsure) including but not limited to medical insurance companies, non-profit insurers, government insurers (e.g., MedGov), including but not limited to federal governments, state governments, Medicare/Medicaid, State Health Networks or any combination thereof.

In one aspect of the invention various group users comprise secondary client users. In some embodiments group users include but are not limited to Employers, Insurance Brokers and Agents, Banks or Health Saving Account (HSA) Administrators, Health Maintenance Organizations (HMO), Regional Health Information Organization (RHIO) or any other similar types of organizations, or any combinations thereof.

In one aspect of the invention, secondary client users are research institutions or organizations. In various embodiments, such research users include but are not limited to clinical research administrator, universities, private institutions, centers for disease control or monitoring (e.g., Center for Disease Control in the U.S.) pharmaceutical manufacturing. For example, clinical data can be uploaded/modified/viewed or generally accessed by various secondary client users through the medmeta server.

In some embodiments, a primary or secondary client user is a clinical research participant or research Subject.

Types of Transactions

In various embodiments, a user (e.g., primary or secondary) is enabled to conduct various transactions through the server platforms.

In one embodiment, a verification transaction is conducted—This special type of transaction is automatically called AFTER any other NEHITS transaction. This transaction is usually automatically generated and sent to party for which authorization is required. The verifying/authorizing party will perform identity verification tasks required, (as defined by the verifying party) and then ask the verifying party to accept or deny the action. The verifying party is the user who is receiving the action.

In one embodiment, an account creation transaction is conducted—Create a new account. Primary or secondary client users can initiate the account setup. Primary account user (e.g., patient/subject) verification is required before the account is activated. Secondary account users include any of such users disclosed herein.

In one embodiment, an associate account is created. An associate account enables another user control to verify on behalf of user creating the associate account. In various embodiments, the associate account is created by a primary and/or secondary client user.

In one embodiment, information/data is posted to an account. For example, a user (primary or secondary) can post information to a primary account user (e.g., patient account in a medical history account).

In one embodiment, a request is submitted for an account (e.g., patient account) for information/data, whereby such a request can be submitted by any authorized user.

In another embodiment, a transaction includes a payment request, for example, where a request is submitted an upon verification automatic payment from payer, patient, or third party is posted to a user's account. In one embodiment, the transfer of funds is effected electronically from a payer's account to a payee's account. As noted herein, a payer can comprise a primary and/or secondary user (e.g., payment of funds from a patient's medical savings account to service provider's account or insurance provider's account). Furthermore, a payee can also include a primary and/or secondary user (e.g., payment from a secondary user's account, such as an insurance provider or employer, to a patient or service provider's account). Therefore, in one embodiment, a payment is sent from one account to another account.

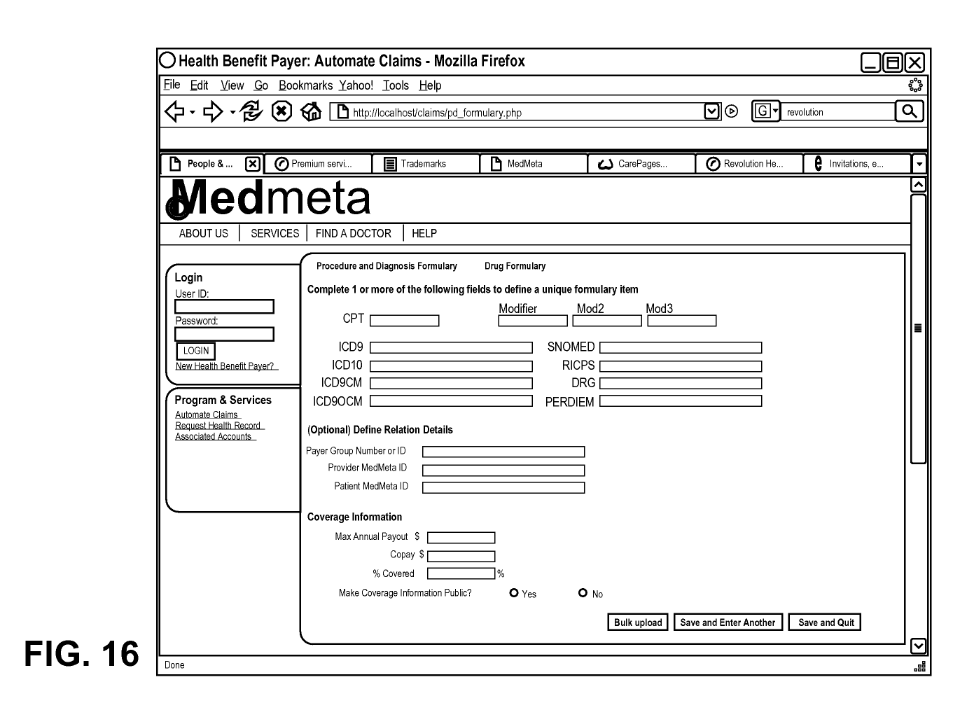

In one embodiment, a transaction includes posting table data. For example, a user can upload table data to allow automatic adjudication of claims. Upload formulary data, payer payment schedules, provider list of procedures. In another embodiment, providers may optionally provide prices for services. For example, a user can input such information using a web portal FIG. 16.

In one embodiment, a transaction includes posting clinical data (e.g., clinical data set). For example, a user can post clinical trial specific dataset(s).

In one embodiment, a transaction includes consolidation of accounts. For example, such an administrative function can consolidate two or more accounts into a single user. Account consolidation request can be initiated can be requested by a primary and/or secondary user. In one embodiment, verification is required by patient and initiator. In another embodiment, verification is required by patient only.

In one embodiment, a transaction includes editing a posted entry (e.g., correcting a posting). For example, such an administrative function will flag incorrect data to be corrected by the original poster. A post correction request can be initiated by a primary and/or secondary user. In one embodiment, the suggested change notification is sent the original poster. In one embodiment, verification and the post correction is requested of the original poster. In yet a further embodiment, if the original poster is not available, then the specific record can be annotated by a secondary client user (e.g., provider), with verification by a primary client user (e.g., patient).

It should be noted, that any of the foregoing transactions are enabled for a primary and/or secondary client user (including a one or more secondary users).

Another aspect of the invention is that certain responses are provided in response to a transaction request. Such responses include but are not limited to a “Success” response (e.g., indicating the transaction was a success). For example, details of the transaction (e.g., receipt) are contained within such a response. In addition, a response can include “Failure” (e.g., indicating the transaction has failed). Similarly, the details the particular error can be contained within the response (e.g., transaction time out, transaction denial, invalid transaction (syntax error)).

The following embodiments provide NEHITS Binary File Structure:

Type 1—Transaction Information: Transaction ID; Account TO; Account FROM; Type of Transaction or Response; Date; or a combination thereof.

Type 2—Personal Textual Data: Patient Name & Demographics; Patient Diet & Exercise; Patient Medications; Patient Allergies; Patient Insurance\Payer(s) Information; Patient Health Saving Account Info; Patient Consent Forms; Patient Living Will\Health Care Directive; Patient Encounter (Diagnosis & Procedures); Patient Textual Lab Results; or a combination thereof.

Type 4—Fingerprint Biometric Images

Type 10—Patient Photo(s)

Type 17—Iris Biometric (Images)

Type 19—Voice Sample (Audio)

Type 50—Arbitrary Binary Attachments (i.e. common image formats, PDF docs)

Type Type 51—DIACOM & Radiology—Images and Annotations

52—DNA Reserved for patient DNA definition

Type 53—Payer Service & Formulary Schedule Record

Type 54—Provider service schedule (i.e. procedures provided, diagnosis specialties, process (optional)

Type 55—Electronic Fund Transfer—where the financial information is contained for an ACH fund transfer.

Type 56—Clinical Trial or Research Specific Data Definition—this is where a clinical trial administrator will define their own data

Type 57—Research Data Query—A Population (i.e. Biosurveillance) query)

Support for Other data Exchange Formats.

Type 60—The HITSP/HL7 container record—where HL7 formatted data is placed.

Type 61—The X12 container record. This is may be used to communicate with Medicare/Medicaid). While the invention has been described hereinabove with reference to a preferred embodiment and various alternatives thereto, it should be apparent that the invention is not limited to such embodiment(s). Rather, many variations would be apparent to persons of skill in the art without departing from the scope and spirit of this invention, as defined in the appended claims.

1-75. (canceled)

76. An identity management method comprising: providing one or more identity verification inputs by said primary client user and/or one or more secondary client users: comparing said identity verification inputs to identity verification data stored on an identity verification subsystem linked to a server, wherein said server comprises a messaging subsystem, wherein if said inputs match said data said user(s) is authorized for access to information on said server, wherein said access comprises different levels of access to different content groupings of said information, wherein said information is particular to said primary client user, wherein said access comprises viewing or modifying said information; accessing of information by a primary client user and one or more secondary client users wherein said information is present on an identify verification subsystem linked to said server, wherein said information is categorized into a plurality of content groups corresponding to a plurality of different access levels, communicating to said primary client user by said messaging subserver notifying said primary client user or one or more preset primary client associates of any said access by any said one or more secondary client user.

77. The method of claim 76, wherein said identity verification input is through voice verification, biometric verification, PIN verification, sound recording verification, password, or a combination thereof.

78. The method of claim 76, wherein said different levels of access comprises open access to verified requesters, access to verified requesters upon approval by said primary client, no access to verified requesters, or a combination thereof.

79. The method of claim 76, wherein said primary client user designates one or more associate accounts linked with said primary client user.

80. The method of claim 79, wherein said at least one or more associate accounts gain access to said information by providing said identify verification input.

81. The method of claim 76, wherein said identify verification is performed by voice recognition algorithm, voice pattern recognition software, keystroke recognition software, sound pattern recognition software, biometric pattern recognition algorithm, biometric pattern recognition software, or a combination thereof.

82. The method of claim 76, wherein said server comprises a file comprising a recording of said primary client's voice.

83. A computer readable medium product comprising an executable software program recorded therein for providing a primary client user and one or more secondary client users access to information comprised in a central server database, wherein said software program provides an identity verification system for authorization of said access, whereby said authorization comprises verification of one or more inputs by said clients in order to authorize said access, wherein a messaging subsystem on said central server provides user to user communication, wherein said primary client designates which of said one or more secondary clients are allowed said access and wherein said communication optionally includes payment exchange between at least two accounts associated with said users.

84. The product of claim 83, wherein said verification of one or more inputs provides multiple layers of security.

85. The product of claim 83, wherein said one or more inputs comprise password, PIN, keyfob, biometrics, an emitted or detectable signal or a combination thereof.

86. The product of claim 85, wherein said biometrics comprises an iris scan, a fingerprint scan, a voice scan, or a combination thereof.

87. The product of claim 85, wherein said emitted or detectable signal is RFI or electromagnetic energy.

88. The product of claim 83, wherein said central server comprises a subserver that resolves CPT procedure codes, ICD-9 diagnosis codes, DRG diagnosis codes, SNOMED codes, prescription formularies, or payment schedules.

89. A content exchange platform system that provides identity verification of one or more users wherein said one or more clients utilize one or more interfaces to input information into a identity verification subsystem comprised in a central server of a client-server architecture computer network, wherein said server comprises a server interface, wherein said one or more users when authorized can access said content present on said server, wherein said content is grouped into one or more data categories, wherein each of said one or more data categories is associated with one or more security layer, whereby authorization through each of said one or more security layer enables access by said one or more authorized users to each of said one or more associated data categories, wherein said one or more clients comprise a primary client user and one or more secondary client user, wherein said primary user designates which of said one or more secondary user is eligible for said access, and whereby said system provides secured content exchange by or amongst said one or more users through a messaging subsystem.

90. The system of claim 89, wherein said one or more clients comprise a primary user and an associate account holder linked to said primary user.

91. The system of claim 89, wherein said verification subsystem is in communication with said one or more interfaces to input said security information.

92. The system of claim 91, wherein said input security information comprises password, PIN, keyfob, biometrics, detectable signal or a combination thereof.

93. The system of claim 92, wherein said biometrics comprises iris scan, fingerprint scan, vein pattern recognition, face recognition, hand recognition, voice scan or a combination thereof.

94. The system of claim 90, wherein said primary user or said secondary user further comprise one or more associate accounts.

95. The system of claim 94, wherein said associate accounts are configured to allow access to said one or more security layer corresponding to said one or more data categories.

96. The system of claim 89, wherein at least one special client is provided with a master authorization to provide access to said content.
